(19) United States
(12) Patent Application Publication
(10) Pub. No.: US 2015/0206246 A1
(43) Pub. Date: Jul. 23, 2015

(54) SYSTEMS AND METHODS FOR CROWDSOURCING OF ALGORITHMIC FORECASTING

(71) Applicants: Jeffrey S. Lange, Chicago, IL (US); Marcos López de Prado, Harrison, NY (US)

(72) Inventors: Jeffrey S. Lange, Chicago, IL (US); Marcos López de Prado, Harrison, NY (US)

(21) Appl. No.: 14/672,028

(22) Filed: Mar. 27, 2015

Related U.S. Application Data
(60) Provisional application No. 61/972,095, filed on Mar. 28, 2014.

(51) Int. Cl. G06Q 40/06; G06Q 10/04; G06Q 50/00

(52) U.S. Cl. CPC G06Q 40/06; G06Q 10/04; G06Q 50/01

(57) ABSTRACT

New computational technologies generating systematic investment portfolios by coordinating forecasting algorithms contributed by researchers are provided. Work on challenges is efficiently facilitated by the algorithmic developer's sandbox (“ADS”). Second, the algorithm selection system performs a batch of tests that selects the best developed algorithms, updates the list of open challenges and translates those scientific forecasts into financial predictions. The algorithm controls for the probability of backtest overfitting and selection bias, thus providing for a practical solution to a major flaw in computational research involving multiple testing. Third, the incubation system verifies the reliability of those selected algorithms. Fourth, the portfolio management system uses the selected algorithms to execute investment recommendations. A dynamically optimal portfolio trajectory is determined by a quantum computing solution to combinatorial optimization representation of the capital allocation problem. Fifth, the crowdsourcing of algorithmic investments controls the workflow and interfaces between all of the hereinabove introduced components.

### CROSS REFERENCE TO RELATED APPLICATIONS

This application claims the benefit of U.S. Provisional Application No. 61/972,095, filed on Mar. 28, 2014, the disclosure of which is expressly incorporated herein by reference thereto.

### FIELD OF THE INVENTION

The present invention relates to systems and method for improved forecasting and generation of investment portfolios based upon algorithmic forecasts.

### BACKGROUND OF THE INVENTION

Computational forecasting systems are important and widely used as essential tools in finance, business, commerce, governmental agencies, research organizations, environment, sciences, and other institutions. There are myriad different reasons why disparate organizations need to predict as accurately as possible future financial or scientific trends and events. Many different types of forecasting systems and methods have been developed over the years including highly complex and sophisticated financial forecasting systems, business demand forecasting systems, and many other computational forecasting methods and systems. While current methods appear to have justified the expenses incurred in developing and purchasing them, there is a growing demand in many of the above-mentioned types of organizations for accurate, improved, novel, and differentiated computational forecasting algorithms. At least in the financial industry, forecasting systems have had deficiencies including but not limited to products that have limited investment capabilities, models based on spurious relationships, lack of appropriate analysis of overfitting, reliance on staff analysts' discretion, and limited capability to evaluate forecast algorithms. These and other drawbacks may not be limited only to financial systems.

To further clarify, companies have in the past implemented significant software and hardware resources to accurately develop forecast algorithms. In one respect, companies hire a staff of analysts with the primary directive of forecasting. One drawback of this approach is that individuals on the staff appear, over time, to converge to have similar approaches or ideas. As such, diversity in thought and creativity is lost. For example, standard business practice for alpha generation is to hire portfolio managers with good track records, typically expressed in terms of high Sharpe ratios. This often leads to selecting portfolio managers with similar traits, which happened to do well in previous years. And even if these portfolio managers were originally selected for being complementary, their daily interaction and work on the same platform will tend to undermine that sought diversification. The consequence is the misuse of capital and resources, because these portfolio managers will tend to perform as one.

Another drawback is that the individual experts that are focused on a career in a particular field of science are the best people in that field of science to create corresponding forecasting algorithms. Pursuing forecasting algorithm contributions from others can be a deficient approach because those individuals likely have their own primary field of endeavor that is different from the needed field of expertise. Our invention facilitates the contribution of forecasting algorithms by those who are experts in the relevant field of science, so that such contribution does not require them to abandon their field or make a career change.

Another issue of relevance relates to the computer resources that institutions consume to accomplish the development of forecast algorithms and apply to production using the forecast algorithms. In many cases, institutions apply significant computer resources in these endeavors where improvement in the process and improved accuracy can significantly improve (e.g., reduce) the need for computational resources (e.g., memory, processors, network communications, etc.) and thereby provide improved accuracy at a much quicker rate.

Another area of deficiency relates to performance evaluation systems. Traditionally, investment funds allocate capital to portfolio managers or algorithms following a heuristic procedure. Those allocations are reviewed on a quarterly or semi-annual basis, based on previous performance as well as subjective considerations. This inevitably leads to inconsistent and erroneous investment decisions.

Another related issue has to do with problems connected to research-based projects. There is discussion in academic papers that explains problems associated with such research in which the results or proposed forecast algorithms, in the case, can be inaccurate or not trustworthy. This can include situations involving backtest overfitting or selection bias. For example, as multiple tests take place on a same dataset, there is an increased probability of encountering false positives. Because many scientific research processes do not account for this increase in probability of false positives, several scientists have concluded that most published research findings are false, loannidis JPA (2005), Why Most Published Research Findings Are False, PLoS Med 2(8): e124. doi:10.1371/journal.pmed.0020124. Available at http://journals.plos.org/plosmedicine/article?id=10.1371/j ournal.pmed.0020124. A practical solution to address critical flaws in the modern scientific method is therefore in high demand.

Thus in view of the hereinabove, the presently disclosed embodiments of the invention now provide such solutions creating an interface between scientists and investors, and also provide other advantages that are understood from the present disclosure.

### SUMMARY OF THE INVENTION

In accordance with a preferred non-limiting embodiment of the present invention, a computer-implemented system for automatically generating financial investment portfolios is contemplated. The system may comprise an online crowdsourcing site having one or more servers and associated software that configures the servers to provide the crowdsourcing site, and further comprise a database of open challenges and historic data. The site may register experts, who access the site from their computers, to use the site over a public computer network, publishes challenges on the public computer network wherein the challenges include challenges that define needed individual scientific forecasts for which forecasting algorithms are sought, and implements an algorithmic developers sandbox that may comprise individual private online workspaces that are available remotely accessible for use to each registered expert and which include a partitioned integrated development environment comprising online access to algorithm development software, historic data, forecasting algorithm evaluation tools including one or more tools for performing test trials using the historic data, and a process for submitting one of the expert's forecasting algorithms authored in their private online workspace to the system as a contributed forecasting algorithm for inclusion in a forecasting algorithm library.

The system may further comprise an algorithm selection system comprising one or more servers and associated software that configures the servers to provide the algorithm selection system, wherein on the servers, the algorithm selection system receives the contributed forecast algorithms from the algorithmic developers sandbox, monitors user activity inside the private online workspaces including user activity related to the test trials performed within the private online workspaces on the contributed forecasting algorithms before the contributed forecasting algorithms were submitted to the system, determines from the monitored activity test related data about the test trials performed in the private online workspaces on the contributed forecasting algorithms including identifying a specific total number of times a trial was actually performed in the private online workspace on the contributed forecasting algorithm by the registered user, determines accuracy and performance of the contributed forecasting algorithms using historical data and analytics software tools including determining from the test related data a corresponding probability of backtest overfitting associated with individual ones of the contributed forecasting algorithms, and, based on determining accuracy and performance, identifies a subset of the contributed forecasting algorithms to be candidate forecasting algorithms.

The system may further comprise an incubation system comprising one or more servers and associated software that configures the servers to provide the incubation system, wherein on the servers, the incubation system receives the candidate forecasting algorithms from the algorithm selection system, determines an incubation time period for each of the candidate forecasting algorithms by receiving the particular probability of backtest overfitting for the candidate forecasting algorithms and receiving minimum and maximum ranges for the incubation time period, in response determines a particular incubation period that varies between the maximum and minimum period based primarily on the probability of backtest overfitting associated with that candidate forecasting algorithm, whereby certain candidate forecasting algorithms will have a much shorter incubation period than others, includes one or more sources of live data that are received into the incubation system, and applies the live data to the candidate forecasting algorithms for a period of time specified by corresponding incubation time periods, determines the accuracy and performance of the candidate forecasting algorithms in response to the application of the live data including by determining accuracy of output values of the candidate forecast algorithms when compared to actual values that were sought to be forecasted by the candidate forecasting algorithms, and in response to determining accuracy and performance of the candidate forecasting algorithms, identifies and stores a subset of the candidate forecasting algorithms as graduate forecasting algorithms as a part of a portfolio of operational forecasting algorithms that are used to forecast values in operational systems.

In a further embodiment, the system may implement a source control system that tracks iterative versions of individual forecast algorithms, while the forecast algorithms are authored and modified by users in their private workspace. The system may determine test related data about test trials performed in the private workspace in specific association with corresponding versions of an individual forecasting algorithm, whereby the algorithm selection system determines the specific total number of times each version of the forecasting algorithm was tested by the user who authored the forecasting algorithm. The system may determine the probability of backtest overfitting using information about version history of an individual forecast algorithm as determined from the source control system. The system may associate a total number of test trials performed by users in their private workspace in association with a corresponding version of the authored forecasting algorithm by that user. The system determines, from the test data about test trials including a number of test trials and the association of some of the test trials with different versions of forecast algorithms, the corresponding probability of backtest overfitting.

In a further embodiment, the system may include a fraud detection system that receives and analyzes contributed forecasting algorithms, and determines whether some of the contributed forecasting algorithms demonstrate a fraudulent behavior.

In a further embodiment, the online crowdsourcing site may apply an authorship tag to contributed forecasting algorithm and the computer-implemented system maintains the authorship tag in connection with the contributed forecasting algorithm including as part of a use of the contributed forecasting algorithm as a graduate forecasting algorithm in operation use. The system may determine corresponding performance of graduate algorithms, and then generates an output, in response to the corresponding performance that is communicated to the author identified by the authorship tag. In some embodiments, the output may further communicate a reward.

In a further embodiment, the system may further comprise a ranking system that ranks challenges based on corresponding difficulty.

In a further embodiment, the algorithm selection system may include a financial translator that comprises different sets of financial characteristics that are associated with specific open challenges, wherein the algorithm selection system determines a financial outcome from at least one of the contributed forecasting algorithms by applying the set of financial characteristics to the at least one of the contributed forecast algorithms.

In a further embodiment, the system may further comprise a portfolio management system having one or more servers, associated software, and data that configures the servers to implement the portfolio management system, wherein on the servers, the portfolio management system receives graduate forecasting algorithms from the incubation system, stores graduate forecasting algorithms in a portfolio of graduate forecasting algorithms, applies live data to the graduate forecasting algorithms, and in response, receives output values from the graduate forecasting algorithms, determines directly or indirectly, from individual forecasting algorithms and their corresponding output values, specific financial transaction orders, and transmits the specific financial transaction orders over a network to execute the order. The portfolio management system may comprise at least two operational modes. In the first mode, the portfolio management system processes and applies graduate forecasting algorithms that are defined to have an output that is a financial output and the portfolio management system determines from the financial output the specific financial order. In the second mode, the portfolio management system processes and applies graduate forecasting algorithm that are defined to have an output that is a scientific output, applies a financial translator to the scientific output, and the portfolio management system determines from the output of the financial translator a plurality of specific financial orders that when executed generate or modify a portfolio of investments that are based on the scientific output. The portfolios from these first and second modes are “statically” optimal, in the sense that they provide the maximum risk-adjusted performance at various specific investment horizons.

In another embodiment, the statically optimal portfolios that resulted from the first and second mode are further subjected to a “global” optimization procedure, which determines the optimal trajectory for allocating capital to the static portfolios across time. In this embodiment, a procedure is set up to translate a dynamic optimization problem into an integer programming problem. A quantum computer is configured to solve this integer programming problem by making use of linear superposition of the solutions in the feasibility space. As such, in one embodiment, the portfolio management system may comprise a quantum computer configured with software that together processes graduate forecasting algorithms and indirect cost of associated financial activity, and in response determines modifications to financial transaction orders before being transmitted, wherein the portfolio management system modifies financial transaction orders to account for overall profit and loss evaluations over a period of time. In another embodiment, the portfolio management system may comprise a quantum computer that is configured with software that together processes graduate forecasting algorithms by generating a range of parameter values for corresponding financial transaction orders, partitioning the range, associating each partition with a corresponding state of a qubit, evaluating expected combinatorial performance of multiple algorithms overtime using the states of associated qubits, and determining as a result of the evaluating, the parameter value in the partitioned range to be used in the corresponding financial transaction order before the corresponding financial transaction order is transmitted for execution.

In a further embodiment, the portfolio management system is further configured to evaluate actual performance outcomes for graduate forecasting algorithms against expected or predetermined threshold performance outcomes for corresponding graduate forecast algorithm, based on the evaluation, determine underperforming graduate forecasting algorithms, remove underperforming graduate forecasting algorithms from the portfolio, and communicate actual performance outcomes, the removal of graduate algorithms, or a status of graduate forecasting algorithms to other components in the computer-implemented system. The portfolio management system evaluates performance of graduate forecasting algorithms by performing a simulation after live trading is performed that varies input values and determines variation in performance of the graduate forecasting algorithm portfolio in response to the varied input values, and determines from the variations in performance, to which ones of the graduate forecasting algorithms in the portfolio the variations should be attributed.

In a further embodiment, the algorithm selection system is further configured to include a marginal contribution component that determines a marginal forecasting power of a contributed forecasting algorithm, by comparing the contributed forecasting algorithm to a portfolio of graduate forecasting algorithm operating in production in live trading, determines based on the comparison a marginal value of the contributed forecasting algorithm with respect to accuracy, performance, or output diversity when compared to the graduate forecasting algorithms, and in response, the algorithm selection system determines which contributed forecasting algorithm should be candidate forecasting algorithm based at least partly on the marginal value.

In a further embodiment, the algorithm selection system is further configured to include a scanning component that scans contributed forecasting algorithms, and in scanning searches for different contributed forecasting algorithms that are mutually complementary. The scanning component determines a subset of the contributed forecasting algorithms that have defined forecast outputs that do not overlap.

In a further embodiment, the incubation system may further comprise a divergence component that receives and evaluates performance information related to candidate forecasting algorithm, over time, determines whether the performance information indicates that individual candidate forecasting algorithm systems have diverged from in sample performance values determined prior to the incubation system, and terminates the incubation period for candidate forecasting algorithms that have diverged from their in-sample performance value by a certain threshold.

In accordance with another preferred non-limiting embodiment of the present invention, a computer-implemented system for automatically generating financial investment portfolios is contemplated. In this system, it may include an online crowdsourcing site comprising one or more servers and associated software that configures the servers to provide the crowdsourcing site and further comprising a database of challenges and historic data, wherein on the severs, the site publishes challenges to be solved by users, implements a development system that comprises individual private online workspaces to be used by the users comprising online access to algorithm development software for solving the published challenges to create forecasting algorithms, historic data, forecasting algorithm evaluation tools for performing test trials using the historic data, and a process for submitting the forecasting algorithms to the computer-implemented system as contributed forecasting algorithms.

The system may also include an algorithm selection system comprising one or more servers and associated software that configures the servers to provide the algorithm selection system, wherein on the servers, the algorithm selection system receives the contributed forecast algorithms from the development system, determines a corresponding probability of backtest overfitting associated with individual ones of the received contributed forecasting algorithms, and based on the determined corresponding probability of backtest overfitting, identifies a subset of the contributed forecasting algorithms to be candidate forecasting algorithms.

The system further includes an incubation system comprising one or more servers and associated software that configures the servers to provide the incubation system, wherein on the servers, the incubation system receives the candidate forecasting algorithms from the algorithm selection system determines an incubation time period for each of the candidate forecasting algorithms, applies live data to the candidate forecasting algorithms for a period of time specified by corresponding incubation time periods, determines accuracy and performance of the candidate forecasting algorithms in response to the application of the live data, and in response to determining accuracy and performance of the candidate forecasting algorithms, identifies and stores a subset of the candidate forecasting algorithms as graduate forecasting algorithms as a part of a portfolio of operational forecasting algorithms that are used to forecast values in operational systems.

In accordance with yet another preferred non-limiting embodiment of the present invention, a computer-implemented system for automatically generating financial investment portfolios is contemplated. In this system, it may include a site comprising one or more servers and associated software that configures the servers to provide the site and further comprising a database of challenges, wherein on the severs, the site publishes challenges to be solved by users, implements a first system that comprises individual workspaces to be used by the users comprising access to algorithm development software for solving the published challenges to create forecasting algorithms, and a process for submitting the forecasting algorithms to the computer-implemented system as contributed forecasting algorithms.

The system may also include a second system comprising one or more servers and associated software that configures the servers to provide the second system, wherein on the servers, the second system evaluates the contributed forecast algorithms, and based on the evaluation, identifies a subset of the contributed forecasting algorithms to be candidate forecasting algorithms.

The system may further include a third system comprising one or more servers and associated software that configures the servers to provide the third system, wherein on the servers, the third system determines a time period for each of the candidate forecasting algorithms, applies live data to the candidate forecasting algorithms for corresponding time periods determined, determines accuracy and performance of the candidate forecasting algorithms in response to the application of the live data, and based on the determination of accuracy and performance, identifies a subset of the candidate forecasting algorithms as graduate forecasting algorithms, the graduate forecasting algorithms are a part of a portfolio of operational forecasting algorithms that are used to forecast values in operational systems.

In accordance with yet another preferred non-limiting embodiment of the present invention, a computer-implemented system for developing forecasting algorithms is contemplated. In this system, it may include a crowdsourcing site which is open to the public and publishes open challenges for solving forecasting problems; wherein the site includes individual private online workspace including development and testing tools used to develop and test algorithms in the individual workspace and for users to submit their chosen forecasting algorithm to the system for evaluation.

The system may also include a monitoring system that monitors and records information from each private workspace that encompasses how many times a particular algorithm or its different versions were tested by the expert and maintains a record of algorithm development, wherein the monitoring and recording is configured to operate independent of control or modification by the experts.

The system may further include a selection system that evaluates the performance of submitted forecasting algorithms by performing backtesting using historic data that is not available to the private workspaces, wherein the selection system selects certain algorithms that meet required performance levels and for those algorithms, determines a probability of backtest overfitting and determines from the probability, a corresponding incubation period for those algorithm that varies based on the probability of backtest overfitting.

Counterpart methods and computer-readable medium embodiments would be understood from the above and the overall disclosure. Also, to emphasize, broader, narrower, or different combinations of described features are contemplated, such that, for example features can be removed or added in a broadening or narrowing way.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 depicts an illustrative embodiment of a system for crowdsourcing of algorithmic forecasting in accordance with some embodiments of the present invention.

FIG. 2 depicts an illustrative embodiment of a development system associated with developing an algorithm in accordance with some embodiments of the present invention.

FIG. 3 depicts an illustrative embodiment of a development system associated with developing an algorithm in accordance with some embodiments of the present invention.

FIG. 4 depicts an illustrative embodiment of a selection system associated with selecting a developed algorithm in accordance with some embodiments of the present invention.

FIG. 5 depicts an illustrative embodiment of a selection system associated with selecting a developed algorithm in accordance with some embodiments of the present invention.

FIG. 6 depicts an illustrative incubation system in accordance with some embodiments of the present invention.

FIG. 7 depicts an illustrative incubation system in accordance with some embodiments of the present invention.

FIG. 8 depicts an illustrative management system in accordance with some embodiments of the present invention.

FIG. 9 depicts one mode of capital allocation in accordance with some embodiments of the present invention.

FIG. 10 depicts another mode capital allocation in accordance with some embodiments of the present invention.

FIG. 11 depicts an illustrative embodiment of a crowdsourcing system in accordance with embodiments of the present invention.

FIGS. 12-16 illustrate example data structure in or input/output between systems within the overall system in accordance with embodiments of the present invention.

FIG. 17 depicts an illustrative core data management system in accordance with some embodiments of the present invention.

FIG. 18 depicts an illustrative backtesting environment in accordance with some embodiments of the present invention.

FIG. 19 depicts an illustrative paper trading system in accordance with some embodiments of the present invention.

FIGS. 20-22 depict various illustrative alert notifications and alert management tools for managing the alert notifications in accordance with some embodiments of the present invention.

FIG. 23 depicts an illustrative deployment process or deployment process system in accordance with some embodiments of the present invention.

FIG. 24 depicts a screen shot of an illustrative deployment tool screen from intra web in accordance with some embodiments of the present invention.

FIG. 25 depicts an illustrative parallel processing system in accordance with some embodiments of the present invention.

FIG. 26 depicts an illustrative performance evaluation system in accordance with some embodiments of the present invention.

FIG. 27 depicts an illustrative screen shot of the performance results generated by the performance evaluation system or the performance engine on the intra web in accordance with some embodiments of the present invention.

FIG. 28 depicts a screen shot of an illustrative intra web in accordance with some embodiments of the present invention.

FIG. 29 depicts illustrative hardware and software components of a computer or server employed in a system for crowdsourcing of algorithmic forecasting in accordance with some embodiments of the present invention.

### DETAILED DESCRIPTION OF THE PREFERRED EMBODIMENTS

Improving the accuracy and rate at which forecasting algorithms are developed, tested, and deployed can have significant value to the scientific, business, and financial community. The evaluation of algorithms can involve significant amount of data, processing, and risk (e.g., if the algorithm is inaccurate in production). In addition, the development of forecasting algorithm can be complex and require multiple iterations.

In accordance with embodiments of the present invention, a system is deployed that combines different technical aspects to arrive on improved systems. In one respect, the system implements an online crowdsourcing site that publicizes open challenges for experts to engage. The challenges can be selected by the system automatically based on analysis already performed. The crowdsourcing site can not only publish the challenges but also provide each expert with an online algorithm developers sandbox. The site will give each expert that chooses to register, the ability to work virtually in the sandbox in a private workspace containing development tools such as algorithm development software, evaluation tools, and available storage. The private workspace provides a virtual remote workspace and is partitioned and private from other registered experts so that each expert can develop a forecast algorithm for a challenge independently and in private. In other words, the system is configured to prevent other experts registered on the site from being able to accessor see the work of other experts on the site. However, the system implements certain limitations on maintaining the privacy of in-workspace data or activity as described below.

The system includes the interactive option for the expert to apply historic data to their authored algorithm to test the performance of the algorithm in their workspace. This is accomplished by the system providing the option to perform one or more trials in which the system applies historic data to the expert's authored forecast algorithm. The system will further include additional interactive features such as the ability in which each expert can select to submit and identify one of their authored forecasting algorithms (after conducting test trials in the workspace) to the system for evaluation. In response to the user's selection of an algorithm for contribution, the system will transmit a message from the expert to another part of the system and the message, for example, will contain the contributed forecast algorithm or may have a link to where it is saved for retrieval.

The system includes an algorithm selection system that receives contributed forecasting algorithms from the crowd or registered experts on the site. The algorithm selection system includes features that apply evaluation tools to the contributed forecast algorithm. As part of the evaluation, the system generates a confidence level in association with each contributed forecast algorithm and applies further processing to deflate the confidence level. In particular, the overall system is configured to private workspaces that are partitioned and private between experts, but the system is further configured to track and store at least certain activity within the private workspace. The system is configured to monitor and store information about test trials that the expert performed in the workspace on the contributed algorithm. This includes the number of test trials that the expert performed on the contributed forecast algorithm (e.g., before it was sent to the system as a contribution for evaluation). In the algorithm selection system, the algorithm selection system can select forecasting algorithms based on performing additional testing, or evaluation of the contributed forecasting algorithms and/or can select contributed forecasting algorithms that meet matching criteria such as the type of forecast or potential value of the forecast. In response, the system identifies certain contributed forecasting algorithms as candidate algorithms for more intensive evaluation, in particular testing within an incubation system. As part of this, the system retrieves information about test trials performed in a private workspace and applies that information to determine a deflated confidence level for each contributed forecasting algorithm. In particular, for example, the total number of trials that the expert performed on the algorithm is retrieved and is used to determine a probability of backtest overfitting of the forecast algorithm. Other data, such as from the prior test data in the workspace can also be used as part of this determination and process.

The deflated confidence level can be the same as the probability of backtest overfitting (“PBO”), or PBO can be a component of it. The purpose is that this value is applied by the system to determine the incubation period for each contributed forecasting algorithm that is moving to the next stage as a candidate forecasting algorithm. There are often-times in such systems a standard approach in which a preset incubation period is used for all algorithms. The confidence level, or PBO, is applied by the system to the standard incubation period, and by applying it, the system determines and specifies different incubation periods for different candidate forecasting algorithms. This is one way that the system reduces the amount of memory and computational resources that are used in the algorithm development process. Reducing the incubation period for some candidate forecasting algorithms can also allow a quicker time to production and more efficient allocation of resources.

The determined incubation period is applied in an incubation system that receives candidate forecasting algorithms. The incubation system is implemented to receive live data (current data, e.g., as it is generated and received as opposed to historic data that refers to data from past periods), and to apply the live data to the candidate forecasting algorithms. The incubation system is a pre-production system that is configured to simulate production but without applying the outputs of the candidate forecasting algorithms to real-life applications. For example, in the financial context, the incubation system will determine financial decisions and will generate financial transaction orders but the orders are virtually executed based on current market data at that time. The incubation system evaluates this virtual performance in “an almost production” setting over the specific incubation period. The incubation system evaluates the performance of candidate forecasting algorithms and based on the evaluation, determines which candidate forecasting algorithms should be selected to be graduate forecasting algorithms for inclusion in the portfolio of graduate forecasting algorithms. The portfolio of graduate forecasting algorithms will be part of the production system.

The production system, a system that is in operative commercial production, can include a management system that controls the use of graduate forecasting algorithms in the portfolio. The production system can determine the amount of financial capital that is allocated to different graduate forecasting algorithms. The production system can also apply financial translators to the graduate forecasting algorithms and, based on the information about the financial translators generate a portfolio involving different investments.

Overall, the system and its individual systems or components implement a system for crowdsourcing of algorithmic forecasting (which can include different combination of features or systems as illustratively described herein or would otherwise be understood). With respect to financial systems, the system (which for convenience is also used sometimes to refer to methods and computer readable medium) can generate systematic investment portfolios by coordinating the forecasting algorithms contributed by individual researchers and scientists. In its simplest form, embodiments of the system and method can include i) a development system (as a matter of brevity and convenience, the description of systems, components, features and their operation should also be understood to provide a description of steps without necessarily having to individually identify steps in the discussion) for developing a forecasting algorithm (which is sometimes referred to as a development system, algorithm development system, or algorithmic developer's sandbox), ii) a selection system for selecting a developed algorithm (which is sometimes referred to as an algorithm selection system), iii) an incubation system for incubating a selected algorithm (which is sometimes referred to as an incubation of forecasting algorithms systems), iv) a management system for managing graduate forecasting algorithm (which is sometimes referred to as a portfolio management system or management of algorithmic strategies system), and v) a crowdsourcing system for the development system that is used to promote and develop new high quality algorithms.

For clarification, different embodiments may implement different components in different parts of the system for illustration purposes. In addition, different embodiments may describe varying system topology, communication relationships, or hierarchy. For example, in some embodiments, crowdsourcing is described as a characteristic of the whole system while other embodiments describe online crowdsourcing to be one system as part of an overall group of systems.

As it would be understood, reference to a system means a computer or server configured with software from non-transient memory that is applied to the computer or server to implement the system. The system can include input and output communications sources or data inputs and storage or access to necessary data. Therefore, it would also be understood that it refers to computer-implemented systems and the features and operations described herein are computer implemented and automatically performed unless within the context that user-intervention is described or would normally be understood. If there is no mention of user involvement or intervention, it would generally be understood to be automated.

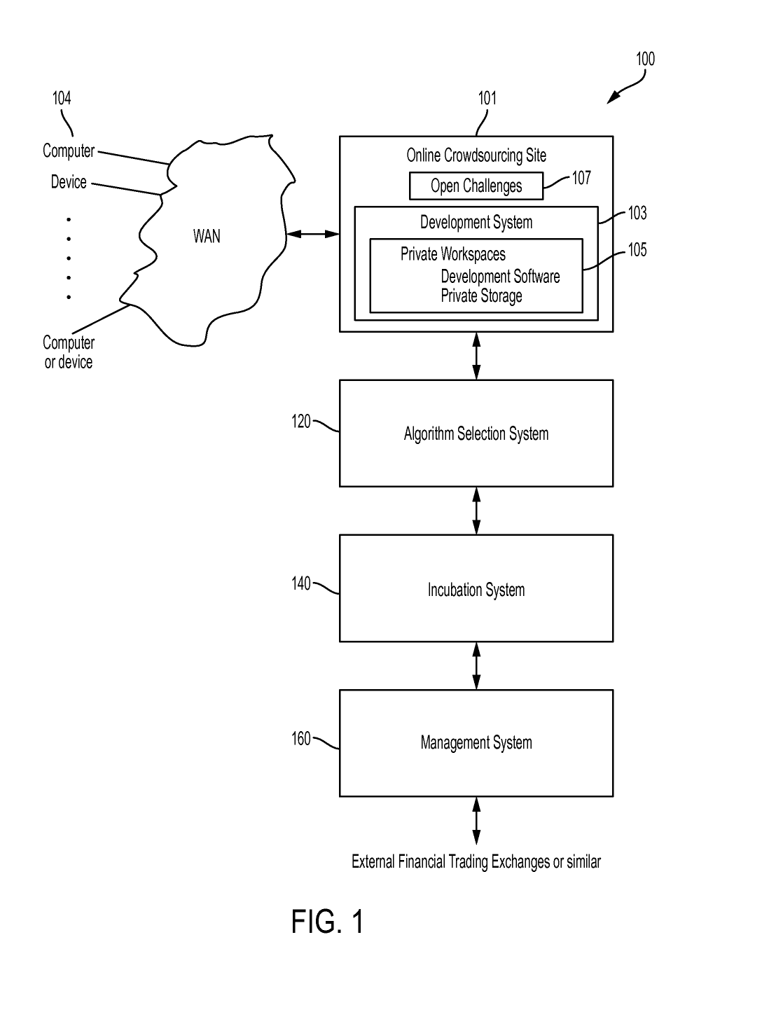

An example of one embodiment in accordance with principles of the present invention is illustratively shown in FIG. 1. Initially, an example of the overall systems and it components is described in connection with FIG. 1, followed by descriptions of features of embodiments of the components or systems that further clarify discussed aspects, detail different embodiments, or provide more detailed descriptions. There are at times some redundancy that may further assist in clarifying and communicating the relationships of the systems and components. In FIG. 1, system 100 for crowdsourcing of algorithmic forecasting and portfolio generation is shown. System 100 comprises an online crowdsourcing site 101 comprising algorithmic developer's sandbox or development system 103, algorithm selection system 120, incubation system 140, and portfolio management system 160. In this figure, the crowdsourcing component is specifically identified as online crowdsourcing site 101, but in operation other parts of the system will communicate with that site or system and therefore could be considered relationally part of a crowdsourcing site.

FIG. 1 depicts that, in one embodiment, development system 103 may include private workspace 103. Online crowdsourcing site 101 can include one or more servers and associated software that configures the servers to provide the crowdsourcing site. Online crowdsourcing site 101 includes a database of open challenges 107 and also contains other storage such as for storing historical data or other data. The online crowdsourcing site 101 or the development system 103 may further comprise a ranking system that ranks the opening challenges based on corresponding difficulty. It should be understood that when discussing a system, it is referring to a server configured with corresponding software and includes the associated operation on the server (or servers) of the features (e.g., including intervention with users, other computers, and networks).

Online crowdsourcing site 101 is an Internet website or application-based site (e.g., using mobile apps in a private network). Site 101 communicates with external computers or devices 104 over communications network connections including a connection to a wide area communication network. The wide area network and/or software implemented on site 101 provide open electronic access to the public including experts or scientists by way of using their computers or other devices 104 to access and use site 101. Site 101 can include or can have associated security or operational structure implemented such firewalls, load managers, proxy servers, authentication systems, point of sale systems, or others. The security system will allow public access to site 101 but will implement additional access requirements for certain functions and will also protect system 100 from public access to other parts of the system such as algorithm selection system 120.

Development system 103 can include private workspace 105. Development system 103 registers members of the public that want user rights in development system 103. This can include members of the general public that found out about site 101 and would like to participate in the crowdsourcing project. If desired, development system 103 can implement a qualification process but this is generally not necessary because it may detract from the openness of the system. Experts can access the site from their computers 104, to use the site over a public computer network (meaning that there is general access by way of public electronic communications connection to view the content of the site, such as to view challenges and to also register). Individuals can register to become users on site 101 such as by providing some of their identifying information (e.g., login and password) and site 101 (e.g., by way of development 103) registers individuals as users on development system 103. The information is used for authentication, identification, tracking, or other purposes.

Site 101 can include a set of open challenges 107 that were selected to be published and communicated to the general public and registered users. It will be understood that systems generally include transient and non-transient computer memory storage including storage that saves for retrieval data in databases (e.g., open challenges) and software for execution of functionality (as described herein, for example) or storage. The storage can be contained within servers, or implemented in association with servers (such as over a network or cloud connection). The challenges include challenges that define needed individual scientific forecasts for which forecasting algorithms are sought. These are forecasts that do not seek or directly seek that the algorithm forecast a financial outcome. The challenges can include other types of forecasting algorithms such as those that seek a forecast of a financial outcome. Each challenge will define a forecasting problem and specify related challenge parameters such as desired outcome parameters (e.g., amount of rain) to be predicted.

Site 101 includes algorithmic developer's sandbox or algorithmic development system 103. Development system 103 includes a private development area for registered users to use to develop forecasting algorithms such as private online workspaces 105. Private online workspace 105 includes individual private online workspaces that are available as remotely accessible places for use to each registered user and which include a partitioned integrated development environment. Each partitioned integrated development environment provides a private workspace for a registered expert to work in to the exclusion of other registered users and the public. The development environment provides the necessary resources to perform the algorithm development process to completion. Private workspaces 105 may also be customized to include software, data, or other resources that are customary for the field of science or expertise of that user. For example, a meteorologist may require different resources than an economist. Development site 103 by way of private workspaces 105 and the development environment therein provides registered users with online access to algorithm development software, historic data, forecasting algorithm evaluation tools including one or more tools for performing test trials using the historic data, and a process for submitting one of the user's forecasting algorithms authored in their private online workspace to the system as a contributed forecasting algorithm for inclusion in a forecasting algorithm portfolio.

The online algorithm development software is the tool that the registered expert uses to create and author forecast algorithms for individual open challenges. Different types or forms of algorithm development software exist and are generally available. At a basic level, it is a development tool that an individual can use to build a forecasting model or algorithm as a function of certain input (also selected by the user). The forecasting algorithm or model is the item that is at the core of the overall system and it is a discrete software structure having one or more inputs and one or more outputs and which contains a set of interrelated operations (which use the input) to forecast a predicted value(s) for a future real life event, activity, or value. Generating an accurate forecasting algorithm can be a difficult and complex task which can have great impact not only in the financial field but in other areas as well.

The partitioned workspace is provided with access to use and retrieve historic data, a repository of past data for use as inputs into each forecasting algorithm. The data repository also includes the actual historic real life values for testing purposes. The forecasting algorithm evaluation tools that are available within the development environment provide software tools for the registered expert to test his or her authored forecasting algorithm (as created in their personal workspace on site 101). The evaluation tools use the historic data in the development environment to run the forecast algorithm and evaluate its performance. The tools can be used to determine accuracy and other performance characteristics. As used herein, the term “accuracy” refers to how close a given result comes to the true value, and as such, accuracy is associated with systematic forecasting errors. Registered experts interact with (and independently control) the evaluation tools to perform testing (test trials) in their private workspace. Overall, site 101 is configured to provide independent freedom to individual experts in their private workspace on site 101 in controlling, creating, testing, and evaluating forecasting algorithms.

Evaluation tools may generate reports from the testing (as controlled and applied by the user), which are stored in the corresponding workspace for that user to review. In some embodiments, development system 103 (or some other system) performs an evaluation of an authored forecasting algorithm in a private workspace without the evaluation being performed or being under the control of the registered expert that authored the forecasting algorithm. The evaluation tools (one or more) can apply historic data (e.g., pertinent historic data that is not available to the expert in their workspace for use in their testing of the algorithm) or other parameters independent of the authoring expert and without providing access to the results of the evaluation report to the authoring expert. Historic data that was not made available for the experts to use in their testing in their workspace is sometimes referred to as out-of-sample data.

In some embodiments, site 101 or some other system can include a component that collects information about individual users activity in their workspace and stores the information external to the private workspaces without providing access or control over the collected information (e.g., expert users cannot modify this information), or stores evaluation reports Generated from the collected information.

Private workspace 105 includes a process for submitting one of the user's forecasting algorithms authored in their private online workspace to the system (e.g., the overall system or individual system such as development system 103) as a contributed forecasting algorithm for inclusion in a forecasting algorithm portfolio. Private workspace 105 can include an interactive messaging or signaling option in which the user can select to send one of their authored forecasting algorithms as a contributed forecasting algorithm for further evaluation.

In response to the selection or submission of a contributed forecasting algorithm, algorithm selection system 120 receives (e.g., receives via electronic message or retrieves) the contributed forecasting algorithm for further evaluation. This is performed across submissions by experts of their contributed forecasting algorithms. Algorithm selection system 120 includes one or more servers and associated software that configures the servers to provide the algorithm selection system. On the servers, the algorithm selection system provides a number of features.

In some embodiments, the algorithm selection system monitors user activity inside the private workspaces including monitoring user activity related to test trials performed within the private online workspaces on the contributed forecasting algorithms before the contributed forecasting algorithms were submitted to the system. This can be or include the generation of evaluations such as evaluation reports that are generated independent of the expert and outside of the expert's private workspace.

The algorithm selection system can include a component that collects information about individual users activity in their workspace and stores the information external to the private workspaces without providing access or control over the collected data (e.g., expert users cannot modify this information), or stores evaluation reports generated from the collected data and it is not available in their private workspace. The component can determine, from the monitored activity, test-related data about test trials performed in the private workspace on the contributed forecasting algorithm including identifying a specific total number of times a trial was actually performed in the private workspace on the contributed algorithm by the registered user. This monitoring feature is also described above in connection with development site 103. In implementation, it relates to both systems and can overlap between or be included as part of both systems in a cooperative sense to provide the desired feature.

Algorithm selection system 120 determines the accuracy and performance of contributed algorithms using historical data and evaluation or analytics software tools including determining, from test data about test trials actually performed in the private workspace, a corresponding probability of backtest overfitting associated with individual ones of the contributed forecasting algorithms. Algorithm selection system 120, based on determining the accuracy and performance, identifies a subset of the contributed forecasting algorithms to be candidate forecasting algorithms.

In preferred embodiments, the system, such as one of its parts, algorithm selection system 120 implements a source control (version control) system that tracks iterative versions of individual forecast algorithms while the forecast algorithms are authored and modified by users in their private workspace. This is performed independent of control or modification by the corresponding expert in order to lock down knowledge of the number of versions that were created and knowledge of testing performed by the expert across versions in their workspace. The system, such as one of its parts, algorithm selection system 120, determines test related data about test trials performed in the private workspace in specific association with corresponding versions of an individual forecasting algorithm, whereby algorithm selection system 120 determines the specific total number of times each version of the forecasting algorithm was tested by the user who authored the forecasting algorithm.

If desired, the system, such as one of its parts, algorithm selection system 120, determines the probability of backtest overfitting using information about version history of an individual forecast algorithm as determined from the source control system. If desired, the system can also associate a total number of test trials performed by users in their private workspace in association with a corresponding version of the authored forecasting algorithm by that user. The system can determine, from the test data about test trials including a number of test trials and the association of some of the test trials with different versions of forecast algorithms, the corresponding probability of backtest overfitting.

Algorithm selection system 120 can include individual financial translators, where, for example, a financial translator comprises different sets of financial characteristics that are associated with specific open challenges. Algorithm selection system 120 determines a financial outcome from at least one of the contributed forecasting algorithms by applying the set of financial characteristics to at least one of the contributed forecast algorithms. In implementation, system 100 can be implemented, in some embodiments, without financial translators. There may be other forms of translators or no translators. The financial translators are implemented as a set of data or information (knowledge) which requires a set of forecast values in order to generate financial trading decisions. The system operator can assess the collection of knowledge and from this set of financial parameters identify challenges, forecasting algorithms that are needed to be applied to the financial translators so as to generate profitable financial investment activities (profitable investments or portfolios over time). The needed forecast can be non-financial and purely scientific or can be financial, such as forecasts that an economist may be capable of making. In some embodiments, preexisting knowledge and system are evaluated to determine their reliance on values for which forecasting algorithms are needed.

Determining trading strategies (e.g., what to buy, when, or how much) can itself require expertise. System 101, if implementing translators, provides the translators as an embodiment of systematic knowledge and expertise known by the implementing company in trading strategies. This incentivizes experts to contribute to the system knowing that they are contributing to a system that embodies an expert trading and investment system that can capitalize on their scientific ability or expertise without the need for the experts to gain such knowledge.

Financial translators or translators (e.g., software) can be used in algorithm selection system 120, incubation system 140, and portfolio management system 160. The translators can be part of the evaluation and analytics in the different systems as part of determining whether a forecasting algorithm is performing accurately, or is performing within certain expected performance levels.

Incubation system 140 receives candidate forecasting algorithm from algorithm selection system 102 and incubates forecasting algorithms for further evaluation. Incubation system 140 includes one or more servers and associates software that configures the servers to provide the incubation system. On the servers, the incubation system performs related features. Incubation system 140 determines an incubation time period for each of the contributed forecasting algorithms. Incubation system 140 determines the period by receiving the particular probability of backtest overfitting for the candidate forecasting algorithms and receives (e.g., predetermined values stored for the system) minimum and maximum ranges for the incubation time period.

In response, incubation system 140 determines a particular incubation period that varies between the maximum and minimum period based primarily on the probability of backtest overfitting associated with that candidate forecasting algorithm, whereby certain candidate forecasting algorithms will have a much shorter incubation period than others. In operation, the system conserves resources and produces accurate forecasts at a higher rate by controlling the length of the incubation period. This is done by monitoring user activity and determining the probability of backtest overfitting using a system structure. This can also avoid potential fraudulent practices (intentional or unintentional) by experts that may compromise the accuracy, efficiency, or integrity of the system.

Incubation system 140 includes one or more sources of live data that are received into the incubation system. Incubation system 140 applies live data to the candidate forecasting algorithms for a period of time specified by corresponding incubation time periods for that algorithm. The system can, in operation, operate on a significant scale such as hundreds of algorithms and large volumes of data such from big data repositories. This can be a massive operational scale.

Incubation system 140 determines accuracy and performance of the candidate forecasting algorithms in response to the application of the live data including by determining the accuracy of output values of the candidate forecast algorithms when compared to actual values that were sought to be forecasted by the candidate algorithms. In response to determining accuracy and performance of the candidate forecasting algorithms, incubation system 140 identifies and stores a subset of the candidate forecasting algorithms as graduate forecasting algorithms as a part of a portfolio of operational forecasting algorithms that are used to forecast values in operational/production systems. In operation, incubation system 140 is implemented to be as close to a production system as possible. Live data, referring to current data such as real time data from various sources, are received by the candidate forecasting algorithms and applied to generate the candidate forecasting algorithm's forecast value or prediction before the actual event or value that is being forecast occurs. The live data precedes the event or value that is being forecasted and the algorithms are operating while in the incubation system to generate these forecasts. The accuracy and performance of algorithms in the incubation are determined from actuals (when received) that are compared to the forecast values (that were determined by the forecasting algorithm before the actuals occurred).

Incubation system 140 can communicate with a portfolio management system. A portfolio management system can include one or more servers, associated software, and data that configures the servers to implement the portfolio management system. On the servers, portfolio management system 160 provides various features. Portfolio management system 160 receives graduate forecasting algorithms from incubation system 140. Portfolio management system 160 stores graduate forecasting algorithms in a portfolio of graduate forecasting algorithms and applies live data to the graduate forecasting algorithms and, in response, receives output values from the graduate forecasting algorithms. Portfolio management system 160 determines directly or indirectly, from individual forecasting algorithms and their corresponding output values, specific financial transaction orders. Portfolio management system 160 transmits the specific financial transaction orders over a network to execute the order. The orders can be sent to an external financial exchange or intermediary for execution in an exchange. In this way, stock order or other financial investment can be fulfilled in an open or private market. The orders can be in a format that is compatible with the receiving exchange, broker, counterparty, or agent. An order when executed by the external system will involve an exchange of consideration (reflected electronically) such as monetary funds for ownership of stocks, bonds, or other ownership vehicle.

Portfolio management system 160 is a production system that applies forecasting algorithms to real life applications of the forecasts before the actual value or characteristic of the forecasts are known. In the present example, forecasts are applied to financial systems. The system will operate on actual financial investment positions and generate financial investment activity based on the forecast algorithms. The system may in production execute at a significant scale or may be in control (automatic control) of significant financial capital.

Portfolio management system 160, in some embodiments, can include at least two operational modes, wherein in a first mode, portfolio management system 160 processes and applies graduate forecasting algorithms that are defined to have an output that is a financial output. Portfolio management system 160 determines from the financial output the specific financial order. In a second mode, portfolio management system 160, in some embodiments, processes and applies graduate forecasting algorithms that are defined to have an output that is a scientific output, applies a financial translator to the scientific output, and determines from the output of the financial translator a plurality of specific financial orders that when executed generate or modify a portfolio of investments that are based on the scientific output.

Portfolio management system 160 is further configured to evaluate actual performance outcomes for graduate forecasting algorithms against expected or predetermined threshold performance outcomes for corresponding graduate forecast algorithm, and based on the evaluation, determine underperforming graduate forecasting algorithms. In response, portfolio management system 160 removes underperforming graduate forecasting algorithms from the portfolio. Portfolio management system 160 can communicate actual performance outcomes, the removal of graduate algorithms, or a status of graduate forecasting algorithms to other components in the computer-implemented system.

In some embodiments, portfolio management system 160 evaluates performance of graduate forecasting algorithms by performing a simulation after live trading is performed that varies input values and determines variation in performance of the graduate forecasting algorithm portfolio in response to the varied input values, and determines from the variations in performance to which ones of the graduate forecasting algorithms in the portfolio the variations should be attributed. Using this identification, portfolio management system 160 removes underperforming graduate forecasting algorithms from the portfolio.

The management system can gradually reassess capital allocation objectively and, in real-time, gradually learn from previous decisions in a fully automated manner.

In some embodiments, online crowdsourcing site 101 (e.g., within development system 103) applies an authorship tag to individual contributed forecasting algorithms and the system maintains the authorship tag in connection with the contributed forecasting algorithms including as part of a use of the contributed forecasting algorithm in the overall system such as in connection with corresponding graduate forecasting algorithms in operational use. The system determines corresponding performance of graduate algorithms and generates an output (e.g., a reward, performance statistics, etc.) in response to the corresponding performance that is communicated to the author identified by the authorship tag. As such, the system can provide an added incentive of providing financial value to individuals who contributed graduate forecasting algorithms. The incentive can be tied to the performance of the graduate algorithm, or the actual financial gains received from the forecast algorithm.

If desired, the system can include a fraud detection system that receives and analyzes contributed forecasting algorithms and determines whether some of the contributed forecasting algorithms demonstrate fraudulent behavior.

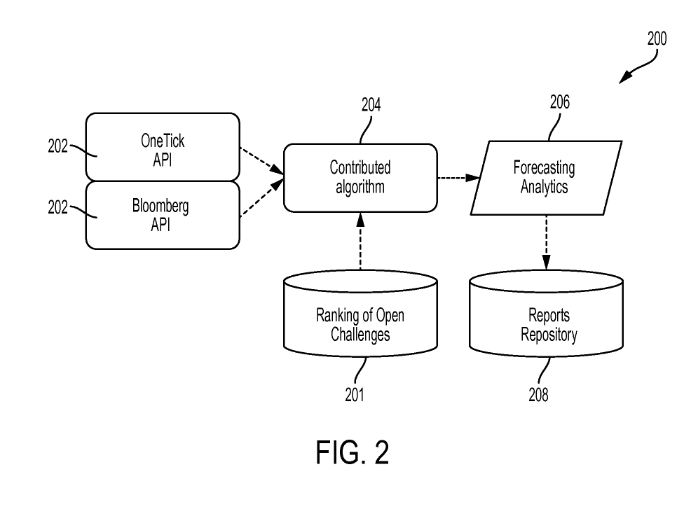

FIG. 2 depicts features of one embodiment a development system 200 for developing a forecasting algorithm. Development system 200 includes first database 201 storing hard-to-forecast variables that are presented as challenges to scientists and other experts (or for developing an algorithm), second database 202 storing structured and unstructured data for modeling the hard-to-forecast variables (or for verifying the developed algorithm), analytics engine 206 assessing the degree of success of each algorithm contributed by the scientists and other experts, and report repository 208 storing reports from evaluations of contributed algorithm.

Development system 200 communicates to scientists and other experts a list of open challenges 201 in the form of variables, for which no good forecasting algorithms are currently known. These variables may be directly or indirectly related to a financial instrument or financial or investment vehicle. A financial instrument may be stocks, bonds, options, contract interests, currencies, loans, commodities, or other similar financial interests. Without being limited by theory, as an example, a forecasting algorithm directly related to a financial variable could potentially predict the price of natural gas, while a forecasting algorithm indirectly related to a financial variable would potentially predict the average temperatures for a season, month or the next few weeks. Through the selection system, such as the incubation system, management system, and online crowdsourcing system, the variable that is indirectly related to finance is translated through a procedure, such as a financial translator. The translation results in executing investment strategy (based on the forecast over time).

Development system 200 (which should be understood as development system 103 in FIG. 1) provides an advanced developing environment which enables scientists and other researchers to investigate, test and code those highly-valuable forecasting algorithms. One beneficial outcome is that a body of practical algorithmic knowledge is built through the collaboration of a large number of research teams that are working independently from each other, but in a coordinated concerted effort through development system 200. In order for the scientists and other experts to begin developing the algorithms 204, as described hereinabove, hard-to-forecast variables which are presented as open challenges 201 to the scientists and other experts, initiates the development process. For example, an open challenge in database 201 could be the forecasting of Non-Farm Payroll releases by the U.S. Department of Labor. Development system 200 may suggest a number of variables that may be useful in predicting future readings of that government release, such as the ADP report for private sector jobs. Development system 200 may also suggest techniques such as but not limited to the X-13 ARIMA or Fast Fourier Transformation (FFT) methods, which are well-known to the skilled artisan in order to adjust for seasonality effects, and provide class objects that can be utilized in the codification of the algorithm 204. If desired, these can be limited to challenges in order to predict or forecast variations in data values that are not financial outcomes. A series of historical data resources or repositories 202 (data inputs for forecast algorithms) are used by the scientists in order to model those hard-to-forecast variables.

In the preferred embodiments, historical data repositories 202 could, for example, be composed of a structured database, such as but not limited to tables, or unstructured data, such as collection of newswires, scientific and academic reports and journals or the like. Hence historical data resources 202 are used by the scientists in order to collect, curate and query the historical data by running them through the developed algorithms or contributed algorithms 204 using forecasting analytics engine 206. The forecasting analytics engine comprises algorithm evaluation and analytics tools for evaluating forecasting algorithms. Subsequent to running historical data 202 through the contributed algorithms 204, the analytics engine outputs the analysis and a full set of reports to repository 208. The reports and outputs are generated for the primary purpose of analyzing the forecasting algorithms 204, and how well and accurate the algorithms are serving their purpose.

In some embodiments, reports that are created in forecasting analytics engine 206 are made available to the corresponding scientists and other experts who authored the algorithm, such that they can use the information in order to further improve their developed algorithms. In other embodiments, some of the reports may be kept private in order to control for bias and the probability of forecast overfitting.

As discussed above, as part of registration with development system 200, scientists are given individual logins that afford them the possibility of remote access to virtual machines. Private workspaces can be provided through a cluster of servers with partitions reserved to each user that are simulated by virtual machines. These partitions can be accessed remotely with information secured by individual password-protected logins. In these partitions, scientists can store their developed algorithms, run their simulations using the historical data 202, and archive their developed reports in repository 208 for evaluating how well the algorithms perform.

As such, analytics engine 206 assesses the degree of success of each developed algorithm. As discussed above, such evaluation tools are accessible in private workspace and under user control and if desired are accessible by the system or system operation to evaluate and test algorithms without the involvement, knowledge or access of the authoring scientist/expert.

In some embodiments, scientists are offered an integrated development environment, access to a plurality of databases, a source-control application (e.g., source-control automatically controlled by the system), and other standard tools needed to perform the algorithm development process.

In addition, analytics engine 206 is also used to assess the robustness and overfitting of the developed forecasting model. In its simplest form, a forecasting model is considered overfit when it generates a greater forecasting power by generating a false positive result which is mainly caused by its noise rather than its signal. Thus, in order to overcome the issue with forecast overfitting, it is preferably desired to have as high signal-noise-ratio as possible wherein the signal-noise-ratio compares the level of a desired signal to the level of background noise. Generally, scientists and other experts may also have a tendency to report only positive outcomes, a phenomenon known as selection bias. Not controlling for the number of trials involved in a particular discovery and testing of an algorithm may lead to over-optimistic performance expectations characterized as described hereinabove due to its higher noise than signal detection. As such, analytics engine 206 can evaluate the probability of forecast overfitting conducted by the scientists (as part of the independent evaluation that the system or system operator performs external to private workspaces). This is largely performed by evaluating different parameters, such as the number of test trials for evaluation of the probability of overfitting.

In order to minimize and overcome the problem of forecast overfitting, the Deflated Sharpe Ratio (“DSR”) may be determined, which corrects for two leading sources of performance overestimation, which are i) the selection bias under multiple testing and ii) non-normally distributed returns. In doing so, DSR helps to separate legitimate empirical findings from otherwise erroneous statistical flukes causing high noise/signal ratio. These concepts of how to control the issue of forecast overfitting are readily known to persons having ordinary skill in the art and are more thoroughly described in greater detail in the publications Bailey, David H. and Lopez de Prado, Marcos, The Deflated Sharpe Ratio: Correcting for Selection Bias, Backtest Overfitting and Non-Normality (Jul. 31, 2014). Journal of Portfolio Management, 40 (5), pp. 94-107. 2014 (40th Anniversary Special Issue). Available at SSRN: http://ssrn.com/abstract=2460551, Bailey, David H. and Borwein, Jonathan M. and Lopez de Prado, Marcos and Zhu, Qiji Jim, The Probability of Backtest Overfitting (Feb. 27, 2015). Journal of Computational Finance (Risk Journals), 2015, Forthcoming. Available at SSRN: http://ssrn.com/abstract=2326253 or http://dx.doi.org/10.2139/ssrn.2326253, and Bailey, David H. and Borwein, Jonathan M. and Lopez de Prado, Marcos and Zhu, Qiji Jim, Pseudo-Mathematics and Financial Charlatanism: The Effects of Backtest Overfitting on Out-of-Sample Performance (Apr. 1, 2014). Notices of the American Mathematical Society, 61(5), May 2014, pp. 458-471. Available at SSRN: http://ssrn.com/abstract=2308659 or http://dx.doi.org/10.2139/ssrn.2308659, which disclosures are hereby fully incorporated by reference in their entirety and also included in the Appendix to this application. If desired, the system can apply DSR to deflate or determine a confidence level for each forecasting algorithm.

In addition to the analytics engine, a quantitative due diligence engine can be further added to development system 200 (or as part of another system such as the algorithm selection system). The quantitative due diligence engine carries out a large number of tests in order to ensure that the developed algorithms are consistent and that the forecasts generated are reproducible under similar sets of inputs. Moreover the quantitative due diligence engine also ensures that the developed algorithms are reliable, whereby the algorithm does not crash, or does not fail to perform tasks in a timely manner under standard conditions, and wherein the algorithm does not further behave in a fraudulent way. The development system or the quantitative due diligence engine also processes the trial results in order to determine if the characteristics of the results indicate a fraudulent implementation (or if it is “bona fide,” e.g. that is, the algorithm does not behave in a fraudulent way, e.g., its output complies with Benford's law, results are invariant to the computer's clock, its behavior does not change as the number of runs increases, etc.). A process is performed through an application that receives the results of test trials and processes the results. The process evaluates the distribution or frequency of data results and determines whether the result is consistent with an expected or random distribution (e.g., does the output indicate that the algorithm is genuine). If the process determines based on the evaluation that the algorithm is fraudulent, not bona fide, the system rejects or terminates further evaluation or use of algorithm.

The quantitative due diligence engine can be exclusively accessible to the system or system operator and not the experts in their workspace. The quantitative due diligence engine can provide additional algorithm evaluation tools for evaluating contributed forecasting algorithm. As a matter of process, testing and evaluation is performed by the system, initially, on contributed forecast algorithms. In other words, the system is not configured to evaluate algorithms that are in a work in progress before the expert affirmatively selects an algorithm to submit as a contributed forecasting algorithm to the system.

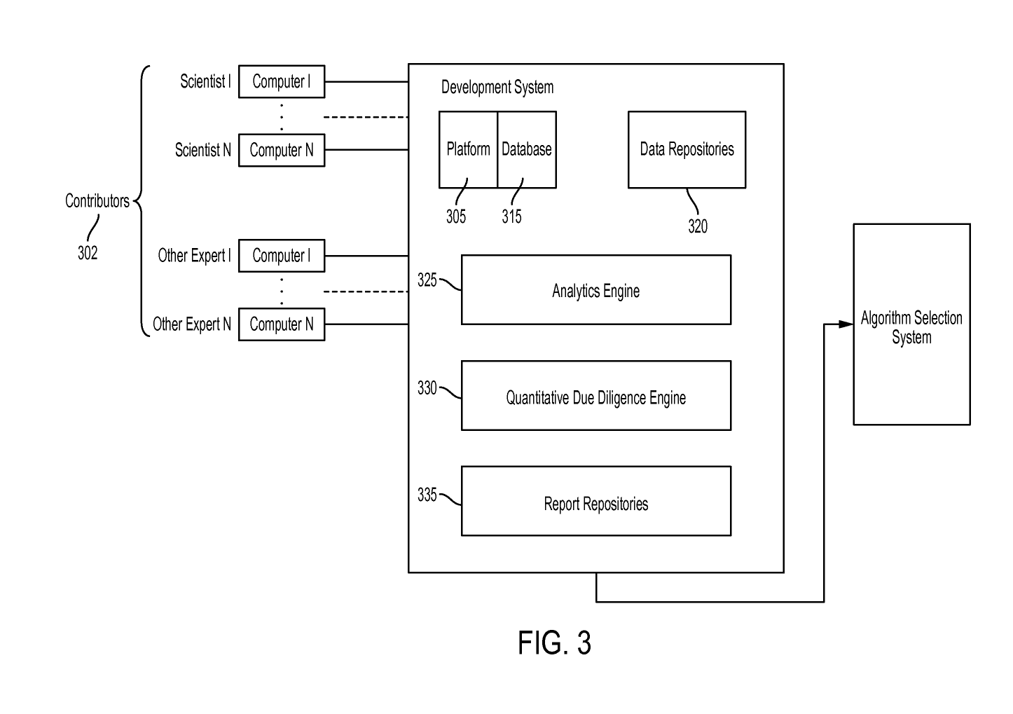

FIG. 3 depicts features of one embodiment of the development system. As shown in FIG. 3, development system 300 may comprise a platform 305 for developing an algorithm and first database 315 for storing hard-to-forecast variables that are presented as challenges to scientists and other experts, second database 320 storing structured and unstructured data for modeling the hard-to-forecast variables (including historic data), analytics engine 325 for assessing quality of each algorithm contributed by the scientists and other experts, quantitative due diligence engine 330 assessing another quality of each algorithm contributed by the scientists and other experts, and report repository 335 storing each contributed algorithm and assessments of each contributed algorithm.

To develop an algorithm through development system 300, contributors 302, such as scientists and other experts, first communicate with the platform 305 and first database 315 via their computers or mobile devices. Using the hard-to-forecast variables stored in the first database 315 and the tools (e.g., algorithm development software and evaluation tools) provided by platform 305, contributors 302 develop algorithm in their workspace. Contributed algorithms (those selected to be submitted to the system by users from their workspace) are provided to analytics engine 325 (this is for evaluation beyond that which the individual expert may have done). Second database 320 stores structured and unstructured data and is connected to analytics engine 325 to provide data needed by the contributed algorithm under evaluation. Analytics engine 325 runs the data through the contributed algorithm and stores a series of forecasts. Analytics engine 325 then assesses the quality of each forecast. The quality may include historical accuracy, robustness, parameter stability, overfitting, etc. The assessed forecasts can also be analyzed by quantitative due diligence engine 330 where the assessed forecasts are subject to another quality assessment. Another quality assessment may include assessing the consistency, reliability, and genuineness of the forecast. Assessment reports of the contributed algorithms are generated from the analytics engine 325 and the quantitative due diligence engine 330. The contributed algorithms and assessment reports are stored in report repository 335.

The development of an algorithm through the development system 200, 300 concludes with building a repository 208, 335 of the developed algorithms and assessment reports, and the reports repository 208, 335 is subsequently provided as an input to a selection system.

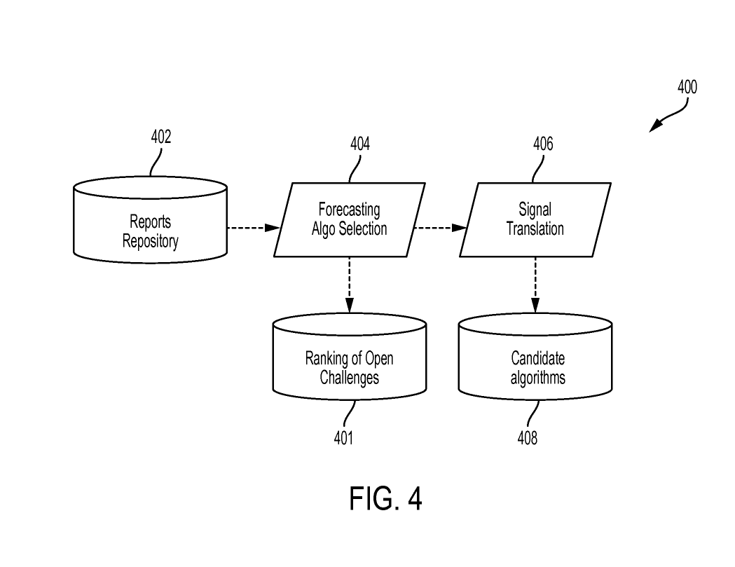

FIG. 4 depicts features of one embodiment of an algorithm selection system (or ASP system) and steps associated with selection system for selecting a developed algorithm. Algorithm selection system 400 evaluates candidate forecasting algorithms from registered experts and based on the evaluation determination determines which ones of the contributed forecasting algorithms should be candidate forecasting algorithms for additional testing. Selection system 400 comprises forecasting algorithm selection system 404, signal translation system 406, and candidate algorithm library 408. The steps associated with selection system 400 for selecting a developed algorithm can include scanning the contributed algorithms and the reports associated with each contributed forecasting algorithm from the reports repository 402. Algorithm selection system 400 selects from among them a subset of distinct algorithms to be candidate forecasting algorithms. Algorithm selection system 400 translates, if necessary, those forecasts into financial forecasts and/or actual buy/sell recommendations 406, produces candidate forecasting algorithms in database 408, stores candidate forecasting algorithms, and updates the list of open challenges in database 401 based on the selection of contributed algorithms for further evaluation.

In forecasting algorithm selection system 404, it may have a scanning component that scan the contributed forecasting algorithms in the reports repository 402 and that, in scanning, searches for different contributed forecasting algorithms that are mutually complementary. The scanning component may also determine a subset of the contributed forecasting algorithms that have defined forecast outputs that do not overlap.

Forecasting algorithm selection system 404 or the algorithm selection system 400 may further have a marginal contribution component that determines the marginal forecasting power of a contributed forecasting algorithm. The marginal forecasting power of a contributed forecasting algorithm, in one embodiment, may be the forecasting power that a contributed forecasting algorithm can contribute beyond that of those algorithms already running in live trading (production). The marginal contribution component, in one embodiment, may determine a marginal forecasting power of a contributed forecasting algorithm by comparing the contributed forecasting algorithm to a portfolio of graduate forecasting algorithms (described below) operating in production in live trading, determining, based on the comparison, a marginal value of the contributed forecasting algorithm with respect to accuracy, performance, or output diversity when compared to the graduate forecasting algorithms, and, in response, the algorithm selection system determines which contributed forecasting algorithms should be candidate forecasting algorithms based on at least partly on the marginal value.

Signal translation system 406 (or financial translators) translates the selected algorithms into financial forecasts or actual buy/sell recommendations since the forecasts provided by the selected algorithms, or selected contributed algorithms, may be directly or indirectly related to financial assets (e.g., weather forecasts indirectly related to the price of natural gas). The resulting financial forecasts, or candidate algorithms are then stored in candidate algorithm library 408. As described hereinabove, the algorithm selection system 404 can include: i) a procedure to translate generic forecasts into financial forecasts and actual buy/sell recommendations; ii) a procedure to evaluate the probability that the algorithm is overfit, i.e., that it will not perform out of sample as well as it does in-sample; iii) a procedure to assess the marginal contribution to forecasting power made by an algorithm and iv) a procedure for updating the ranking of open challenges, based on the aforementioned findings.

Because system 100 for crowdsourcing of algorithmic forecasting provides a unified research framework that logs all the trials occurred while developing an algorithm, it is possible to assess to what an extent the forecasting power may be due to the unwanted effects of overfitting. Thus, in selection system 404, for example, it is reviewed how many trials a given scientist has used in order to develop and test a given algorithm with historical data, and based upon the number of trials used by the scientist, a confidence level is subsequently determined by the analytics engine for the contributed forecasting algorithm. It should be understood that the established confidence level and number of trials used by a given scientist are inversely connected and correlated, such that a high trial number would result in a more greatly deflated confidence level. As used herein, the term “deflated” refers to the lowering of the confidence level determined as described above. If it turns out that a given algorithm is characterized by having a confidence level above a preset threshold level, this specific algorithm would then be qualified as a candidate algorithm in FIG. 4. As a result, advantageously, a lower number of spurious algorithms will ultimately be selected, and therefore, less capital and computation or memory resources will be allocated to superfluous algorithms before they actually reach the production stage. Other techniques can be implemented as alternative approaches or can be combined with this approach.

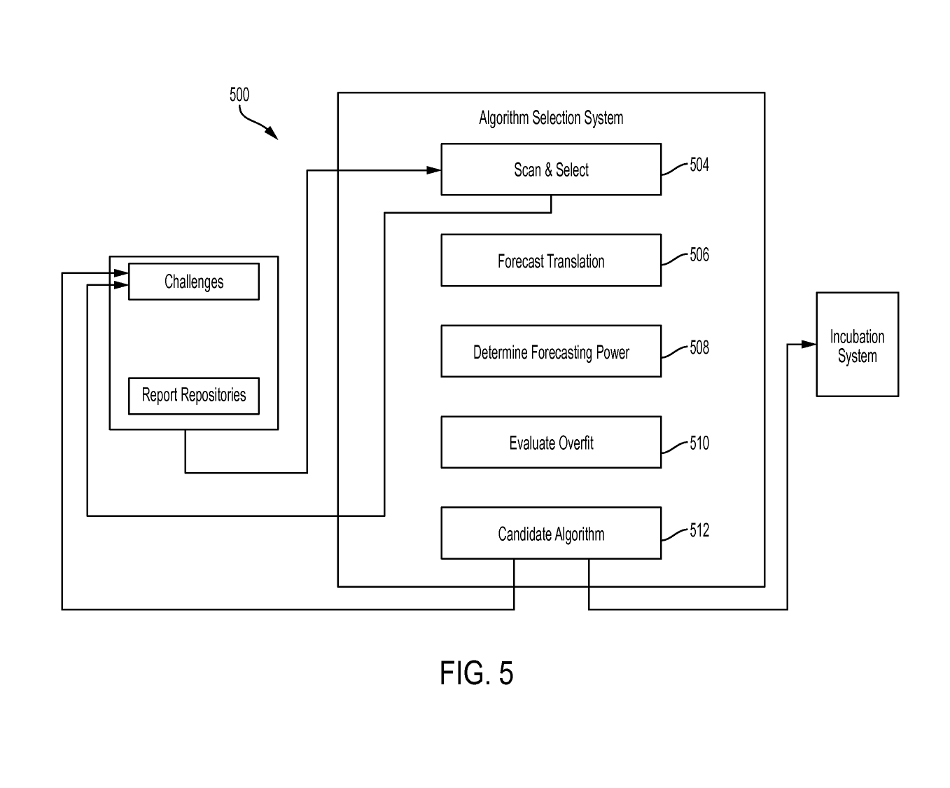

FIG. 5 depicts features of another embodiment of an algorithm selection system. Algorithm selection system 500 can comprise a forecasting algorithm scanning and selection system 504 (may be configured to perform similar functions as the scanning component described above), forecast translation system 506, forecasting power determination system 508 (similar to the marginal contribution system described above and may be configured to perform similar functions), overfitting evaluation system 510, and a candidate algorithm library 408. Algorithm selection system 500 for selecting a developed algorithm to be a candidate algorithm comprises scanning and selecting the developed algorithms from the reports repository, translating the selected algorithms or forecasts into financial forecasts and/or actual buy/sell recommendations (in component 506), and determining the forecasting power of the financial forecasts (in component 508), evaluating overfitting of the financial forecasts (in component 510), and producing and storing candidate algorithms (in component 512).

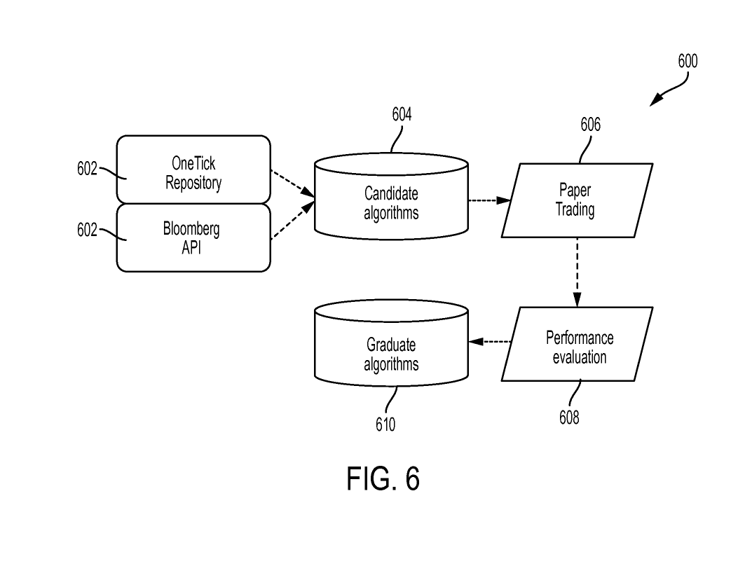

FIG. 6 illustrates features of one embodiment of an incubation system. As shown, incubation system 600 is for incubating candidate forecasting algorithms. Incubation system 600 comprises database or data input feed 602, which stores structured and unstructured data (or historical data) for modeling hard-to-forecast variables, candidate algorithm repository 604, “paper” trading environment 606, and performance evaluation system 608. Database or data input feed 602 may provide an input of live data to the candidate forecasting algorithms. The steps for this feature can include simulating 606 the operation of candidate algorithms in a paper trading environment, evaluating performance of the simulated candidate algorithms, and determining and storing graduate algorithms based on the results of the evaluation.

As described hereinbefore, the candidate algorithms that were determined by the selection system are further tested by evaluating the candidate algorithms under conditions that are as realistically close to live trading as possible. As such, before the candidate algorithms are released into the production environment, they are incubated and tested with data resources that comprise live data or real-time data and not by using the historical data resources as explained previously in the development and selection systems and steps. Data such as liquidity costs, which include transaction cost and market impact, are also simulated. This paper trading ability can test the algorithm's integrity in a staging environment and can thereby determine if all the necessary inputs and outputs are available in a timely manner. A person having ordinary skill in the art would appreciate that this experimental setting gathers further real-time confirmatory evidence such that only reliable candidate algorithms are deployed and used in production, whereas unreliable candidate algorithms are discarded before they eventually reach production. Once again this effectuates efficient capital, resource, and time saving. It is important to keep in mind and stress that candidate algorithms can only reach the incubation system 600 only if the achieved confidence level is found to be higher than a predetermined level. Similarly, in incubation system 600, a higher confidence level is used to require the candidate algorithms to be incubated a less amount of time, and an elevated deflated confidence level (e.g., meaning lower confidence level) will be used by the system so as to require the candidate algorithms to be incubated an increased amount of time. Thus, during the evaluation step 608, incubation system 600 determines if the candidate algorithms passes the evaluation. If the candidate algorithms pass the evaluation, evaluation system 608 outputs the passed candidate algorithms, designates the passed candidate algorithms as graduate algorithms 610, and stores the graduate algorithms in a graduate algorithm repository. Further, candidate algorithms 604 are also required to be consistent with minimizing backtest overfitting as previously described

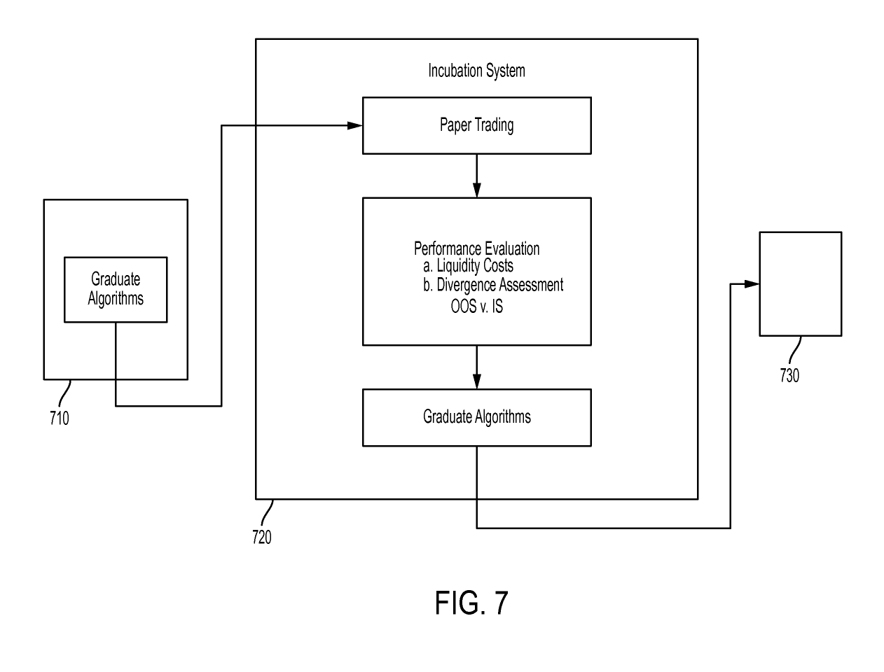

FIG. 7 shows features of one embodiment of an incubation system. As shown, incubation system 720 can communicate using signaling and/or electronic messaging with management system 730. Using the graduate algorithms from the incubation system that provide investment recommendations, management system 730 determines investment strategies or how the capital should be allocated. Incubation system 720 performs “paper” trading on candidate forecasting algorithms. Incubation system 720 evaluates the performance of candidate forecasting algorithms over time such as by factoring in liquidity costs and performing a divergence assessment by comparing in-sample results to results from out-of-sample data. If for example, the paper trading (simulating “live data” production operations without the actual real life application of the output) is not performing within an expected range of performance (e.g., accuracy) from actual data values over a minimum period of time, the corresponding candidate forecasting algorithm is terminated from paper trading and removed. The divergence assessment may be performed by a divergence assessment component of incubation system 720. The divergence assessment component, in one embodiment, may be configured to receive candidate forecasting algorithms from the algorithm selection system, evaluate performance information related to the received candidate forecasting algorithms, determine, over time, whether the performance information indicates that individual candidate forecasting algorithms have diverged from in-sample performance values determined prior to the incubation system (or prior to providing the candidate forecasting algorithms to the incubation system), and terminate the incubation period for candidate forecasting algorithms that have diverged from their in-sample performance value by a certain threshold. The divergence assessment component can for example also evaluate the performance of the forecast algorithm (candidate algorithm) in relation to the expected performance determined from backtesting in an earlier system (e.g., the algorithm selection system) and determines when the performance in the incubation is not consistent with the expected performance from backtesting and terminates the paper trading for that algorithm, which can increase resources for additional testing. For example, the expected profit from earlier testing for a period is X+/−y, the divergence analysis will terminate the incubation system's testing of that algorithm before the incubation period is completed when the performance of the algorithm is below the expected X-y threshold. The divergence assessment component can also applied in operation during production within the portfolio management system. In conventional systems, an algorithm is terminated from production when a preset threshold that is often times arbitrarily selected and applied to all algorithms is satisfied. In some embodiments of the invention, the management system operates at a more efficient and fine-tuned level by comparing the performance results of the algorithm in production to the algorithms performance in earlier systems (incubation, selection, and/or development system) and terminates the algorithm from production when the performance has diverged from the expected earlier performance (performs more poorly than worst expected performance from earlier analysis).

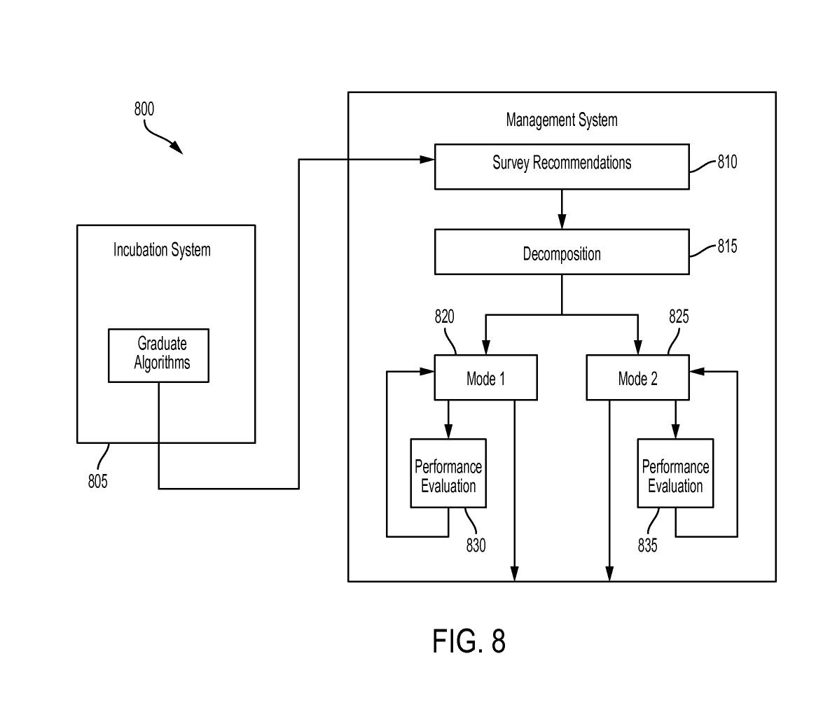

FIG. 8 illustrates features of one embodiment of a portfolio management system 800. Portfolio management system 800 includes steps associated with management system 800 for managing individual graduate algorithms that were previously incubated and graduated from the incubation system. FIG. 8 also shows connections between incubation system 805 and management system 800. Management system 800 may comprise survey system 810, decomposition system 815, first capital allocation system 820, second capital allocation system 825, first evaluation system 830 evaluating the performance of the first capital allocation system 820, and second evaluation system 835 evaluating the performance of second capital allocation system 825. The steps may comprise surveying (or collecting) investment recommendations provided by the graduate algorithms (which in context can sometimes refer to the combination of a graduate algorithm and its corresponding financial translator), decomposing the investment recommendations, allocating capital based on decomposed investment recommendations, and evaluating performance of the allocation.

In decomposition system 815, space forecasts are decomposed into state or canonical forecasts. Space forecasts are the result forecasts on measurable financial variables, or in simpler terms, the financial forecasts provided by the graduate algorithms. The decomposition may be performed by procedures such as Principal Components Analysis (“PCA”), Box-Tiao Canonical Decomposition (“BTCD”), Time Series Regime Switch Models (“TSRS”), and others. The canonical forecasts can be interpreted as representative of the states of hidden “pure bets.” For example, a space forecast may be a forecast that indicates that the Dow-Jones index should appreciate by 10% over the next month. This single forecast can be decomposed on a series of canonical forecasts such as equities, U.S. dollar denominated assets, and large capitalization companies. By decomposing every forecast into canonical components, the system can manage and package risk more efficiently, controlling for concentrations. Capital can then be allocated to both types of forecasts, resulting in different portfolios.

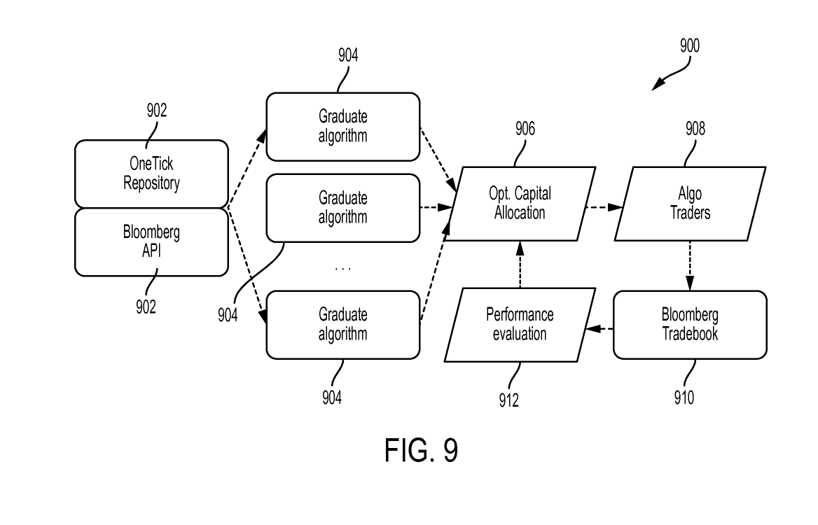

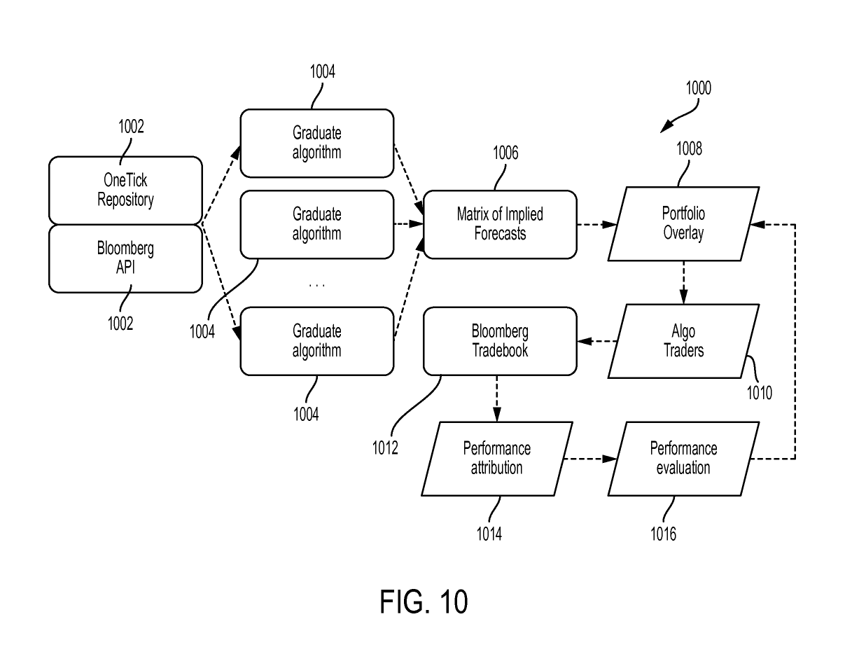

Capital allocation may have two modes as depicted in FIGS. 9 and 10. In the first mode 900, optimal capital allocations 906 are made to graduate algorithms 904 based on their relative performance. These optimal capital allocations 906 determine the maximum size of the individual algorithms' 906 positions. Portfolio positions are the result of aggregating the positions of all algorithms 906. In simple terms, it should be understood by a skilled artisan that in the first mode 900, single actual buying/selling recommendations are made, and orders are automatically generated by algorithm trader system 908, which is followed by step 910, wherein the financial backed activities are performed and completed and during step 912, the performance of the graduate algorithms 904 is thus evaluated. To better define this concept, single buying/selling recommendations are executed, which could be, e.g., buying/selling oil or buying/selling copper, or buying/selling gold, etc. As such, in the first mode, a portfolio of investments are not conducted, as it solely pertains to single buying/selling recommendations based on forecasting graduate algorithm 906.

In the second mode 1000, investment recommendations are translated into forecasts on multiple time horizons. The system's confidence level on those forecasts is a function of the algorithms' 1004 past performance and a portfolio overlay is run on those forecasts. In simple terms, in the second mode 1000, multiple buying/selling recommendations are made and orders are automatically in real-time generated by algorithm trading system 1010. This is followed by step 1012, wherein financial backed activities are performed and completed. During step 1014, the performance of the graduate algorithms 1004 are evaluated in step 1016. As such, in the second mode, every forecast is decomposed into individual canonical components which affords improved risk management for the individual or organization. If during the performance evaluation in step 1016, some of the graduate algorithms 1004 do not perform as expected, a new portfolio overlay may then be performed in step 1008. Moreover, since the resulting portfolio is not a linear combination of the original recommendations in the second mode (unlike the first mode in which individual algorithms' performance can be directly measured), performance needs to be attributed 1014 back to the graduate strategies. This attribution 1014 is accomplished through a sensitivity analysis, which essentially determines how different the output portfolio would have been if the input forecasts had been slightly different.

Generalized dynamic portfolio optimization problems have no known closed-form solution. These problems are particularly relevant to large asset managers, as the costs from excessive turnover and implementation shortfall may critically erode and influence the profitability of their investment strategies. In addition, and essentially, an investor's own decisions, as well as the entire investment market will directly influence the price of a given share, and as such, there is still an unmet need to implement and incorporate systems and methods that can aid in better determining how to optimize the portfolio, how much to buy/sell, and thereby maximize the portfolio with forecasts that exhibit the ability to predict and pre-calculate an output of prices at multiple horizons. As used herein, the term “horizon” refers to different time-points. Without being limited by theory, for example, some forecasts could refer to an optimized portfolio comprising rice over the next year, stocks over the next 3 months, and soybeans over the next 6 months. Since forecasts involve multiple horizons, the optimal portfolios at each of these horizons would have to be determined, while at the same time, minimizing the transaction costs involved in those portfolio rotations. This financial problem can be reformulated as an integer optimization problem, and such representation makes it amenable to be solved by quantum computers. Standard computers only evaluate and store feasible solutions sequentially, whereas the goal and ability of quantum computers is to evaluate and store all feasible solutions all at once. Now the principle of integer optimization will be explained in greater detail. The whole purpose of quantum computing technology is to pre-calculate an output, and thereby determining an optimal path through calculating the optimal trading trajectory ω, which is an N×H matrix, wherein N refers to assets and H defines horizons. This can be envisioned by establishing a specific portfolio, which can for example be comprised of K units of capital that is allocated among N assets over X amount of months, e.g. horizons. For each horizon, the system would then create partitions or grids of a predetermined value set by the system. For example, if the system has been set to create partitions of incremental increase or decrease of a value of 10, it would then pre-calculate an investment output r for share numbers that either increase or decrease by the value of 10, such that, if for example 1000, 2000, 3000 contracts of soybean were bought in January, March and May, respectively, the system would then be able to compute and pre-calculate the optimal trading trajectory ω at 990, 980, 970 contracts, etc. or 1010, 1020, 1030 contracts, etc. for January. Similar computing would be executed for March, which would in this case be for 1990, 1980, 1970, etc. or 2010, 2020, 2030, etc. contracts and for May, e.g. 2990, 2980, 2970, etc. or 3010, 3020, 3030, etc. In this example, an incremental increase or decrease of a partition of the value 10 is chosen and is shown merely as an example, but a person of ordinary skill in the art would readily know and understand that the partition could advantageously also assume a value of 100, 50, 25, 12, etc. such that it would either decrease or increase incrementally by the aforementioned values. The system would then be able to determine the optimal path of the entire portfolio at multiple horizons from the pre-calculated values, as well as over many different instruments.

The system is configured to apply an additional portfolio management aspect that takes into the account indirect cost of investment activity. For example, it can estimate the expected impact to a stock price in response to trading activity (such as if the system decided to sell a large volume in a stock). It also does this across many algorithms or investment positions. As such, where each algorithm may be capable in specifying the best position for each of a set of different investment (e.g., at a particular time), the system can apply this additional level of processing (having to do with indirect costs) and take into other factors such as investment resources and determine a new optimal/best investment position for the positions that accounts for the quantum issue. The system can implement the process on a quantum computer because the fundamental way that such computers operate appears to be amenable to this situation. The qubits of the quantum computer can have direct correspondence to the partitioned sections of an individual investment/stock. In one embodiment, the quantum computer is configured with software that together processes graduate forecasting algorithms and indirect cost of associated financial activity and in response determines modifications to financial transaction orders before being transmitted, wherein the portfolio management system modifies financial transaction orders to account for overall profit and loss evaluations over a period of time. In another embodiment, the quantum computer is configured with software that together processes graduate forecasting algorithms by generating a range of parameter values for corresponding financial transaction orders, partitioning the range, associating each partition with a corresponding state of a qubit, evaluating expected combinatorial performance of multiple algorithms overtime using the states of associated qubits, and determining as a result of the evaluating, the parameter value in the partitioned range to be used in the corresponding financial transaction order before the corresponding financial transaction order is transmitted for execution. Consequently the advantage of employing quantum computers can make processing and investment much easier as they provide solutions for such high combinatorial problems.

A skilled artisan would appreciate that from a mathematical perspective, taking the previously defined N×H matrix into account, assuming as an example that K=6 and N=3, the partitions (1, 2, 3) and (3, 2, 1) are treated differently by the system, which means that all distinct permutations of each partition are considered. As used herein the term “permutation” relates to the act of rearranging, or permuting, all the members of a set into a special sequence or order. Thus if K assumes the value 6, and N assumes the value 3, each column of ω can adopt one of the following 28 arrays:

[[1, 1, 4], [1, 4, 1], [4, 1, 1], [1, 2, 3], [1, 3, 2], [2, 1, 3], [3, 1, 2], [2, 3, 1], [3, 2, 1], [1, 5, 0], [1, 0, 5], [5, 1, 0], [0, 1, 5], [5, 0, 1], [0, 5, 1], [2, 2, 2], [2, 4, 0], [2, 0, 4], [4, 2, 0], [0, 2, 4], [4, 0, 2], [0, 4, 2], [3, 3, 0], [3, 0, 3], [0, 3, 3], [6, 0, 0], [0, 6, 0], [0, 0, 6]].

Since ω has H columns, there would be 28^{H} possible trajectory matrices ω. For each of these possible trajectories, as explained hereinabove, the system would then compute the investment output r of the optimal trading trajectory ω. This procedure is highly computationally intensive. However, quantum computers offer the advantage of simulating multiple matrices for various risk scenarios, such that better and improved investment decisions and strategies can be executed as described and detailed hereinabove. Examples of systems, formulas and application that support features herein are described in greater detail in the following article, which is hereby incorporated herein by reference in its entirety and also included in the Appendix to this application: Lopez de Prado, Marcos, Generalized Optimal Trading Trajectories: A Financial Quantum Computing Application (Mar. 7, 2015), which is available at SSRN: or http://ssrn.com/abstract=2575184 or http://dx.doi.org/10.2139/ssrn.2575184.

As discussed above, the portfolio management system can implement a divergence process that determines whether to terminate certain algorithms. This is performed by determining the performance of individual algorithms and comparing to the algorithm's performance in development, selection, and/or incubation system. For example, in the portfolio management system, there is an expected performance and range of performance based on backtesting; an expectation that in production it will move consistent with previous testing. The system will cut off use of the algorithm if it is inconsistent with the expected performance from backtesting. Rather than continue to run the algorithm until a poor threshold in performance is reached, it gets decommissioned because performance is not possible according to backtesting.

In some embodiments, marginal contribution can be a feature that is implemented by starting with a set, e.g., 100, previously identified forecasting algorithms. The set is running in production and generating actual profit and loss. When a new algorithm is identified by the selection system, the marginal value can be determined by the system by computing the performance of a virtual portfolio that includes the set and in addition that one potential new forecasting algorithm. The performance of that combined set is evaluated and the marginal contribution of the new algorithm is evaluated. The greater contribution is evaluated, the more likely it is added to production (e.g., if above a certain threshold).

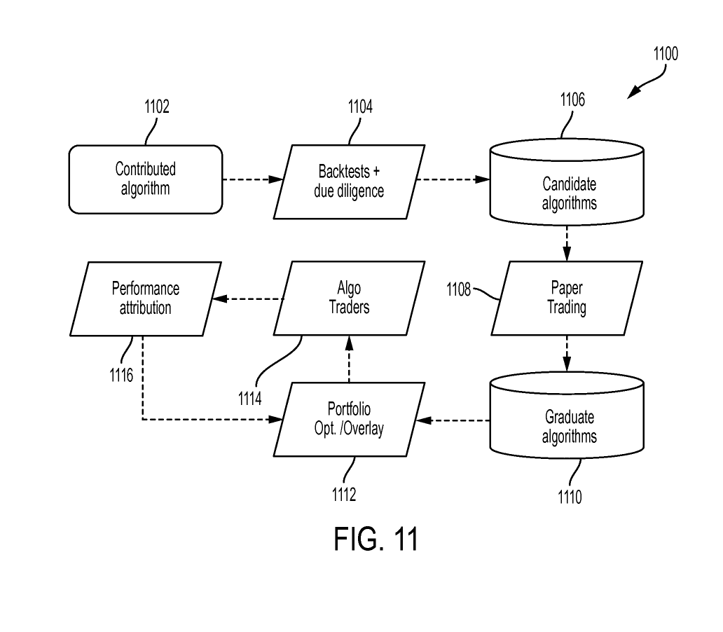

FIG. 11 depicts features of one embodiment of a crowdsourcing system 1100 and steps associated with the crowdsourcing system for coordinating the development system, selection system, incubation system, and management system. The crowdsourcing system 1100 essentially provides the means and tools for the coordination of scientists who are algorithmic developers, testing of their contributions, incubation in simulated markets, deployment in real markets, and optimal capital allocation. Thus, in simple terms, the system 1100 integrates the i) algorithmic developer's sandbox, ii) algorithm selection system, iii) incubation system and iv) management of algorithmic strategies system into a coherent and fully automated research & investment cycle.

The steps performed by system 1100 comprise step 1102 where algorithms are developed by scientists and other experts, and the selected developed algorithms 1102 are received and further undergo due diligence and backtests in step 1104. After evaluating for backtest overfitting and applying a selection process, candidate algorithms 1106 (in a database) are further exercised by evaluating the candidate algorithms 1106 in an incubation process. The candidate algorithms are incubated and tested with live data resources that are obtained in incubation system or step 1108. Graduate algorithms 1110 are obtained and automated single or multiple buying/selling order or recommendations are next conducted (automatically generated) in steps 1112 and 1114 and the performances of the graduated algorithms are then evaluated in step 1116. If during the performance attribution in step 1016, some of the graduate algorithms 610 do not perform as expected, a new portfolio may then be created in step 1112 by, e.g., removing or adding graduate forecasting algorithms.

Thus collectively in sum, the portfolio management system 800 advantageously offers 1) a system that surveys recommendations from the universe of graduate algorithms 904; 2) a system that is able to decompose space forecasts into canonical state forecasts or “pure bets”; 3) a system that computes an investment portfolio as the solution of a strategy capital allocation problem (e.g., first mode 900); 4) a system that computes an investment portfolio as the solution to a dynamic portfolio overlay problem (e.g., second mode 1000); 5) a system that slices orders and determines their aggressiveness in order to conceal the trader's presence; 6) a system that attributes investment performance back to the algorithms that contributed forecasts; 7) a system that evaluates the performance of individual algorithms, so that the system that computes investment portfolios gradually learns from past experience in real-time; 8) building portfolios of algorithmic investment strategies, which can be launched as a fund or can be securitized and 9) building portfolios of canonical state forecasts as “pure bets” rather than the standard portfolios of space forecast.

As discussed above, financial forecasting algorithm is one application of the described technology, and other applications exist. For example, the overall system can be adapted to implement a system that develops and builds a portfolio of forecasting algorithm that are directed to detect fraudulent or criminal behavior. The system can publish open challenges directed to forecasting or predicting the probability of fraudulent or criminal activity. Different challenges can be published. The system can be configured to the private workspace for individuals that want to develop an algorithm to solve one of various challenges directed to such forecasts. The algorithms may identify likely classification of illegal activity based on selected inputs. Overall, the system would operate the same as described herein with respect to financial systems but adapted for forecasting algorithms as a portfolio of algorithms that are specific to determining or predicting fraudulent activity.

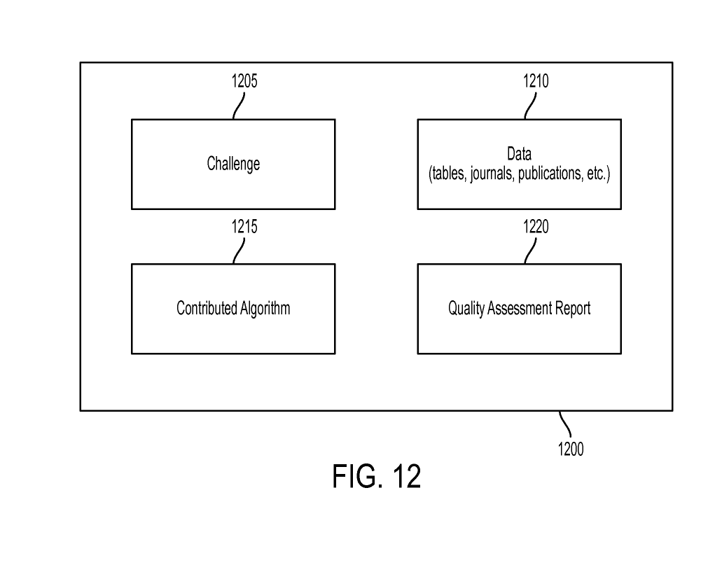

FIGS. 12-16 illustrate different data or structures of different data being stored, applied to or used by systems and/or transmitted between the systems in the performance of related features described herein. Referring to FIG. 12, this figure shows one embodiment of structure 1200 of a data transmitted from the development system to the selection system or a data output by the development system. Structure 1200 may have four components, with first component 1205 being the challenge solved by the contributor, second component 1210 being the historical data used to solve the challenge or to verify the developed algorithm, third component 1215 being the algorithm developed or contributed by the contributor, and fourth component 1220 being quality assessment result of the contributed algorithm.

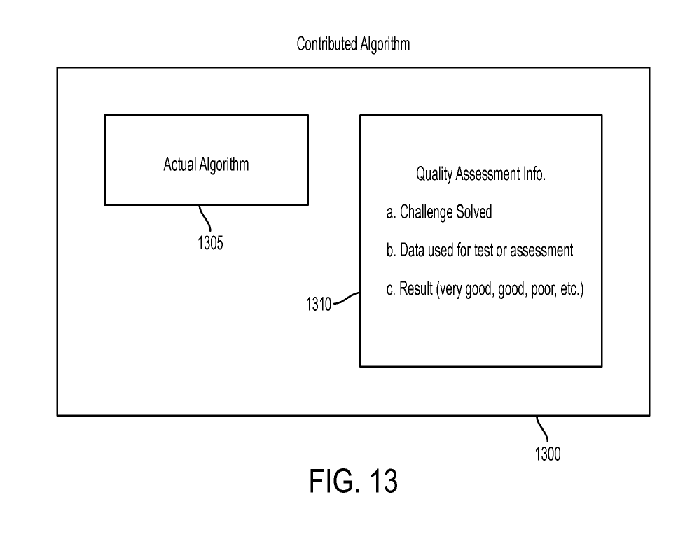

Referring to FIG. 13, this figure shows another embodiment of structure 1300 of the data transmitted from the development system to the selection system or a data output by the development system. Structure 1300 may have only two components, with first component 1305 being the actual algorithm developed or contributed by the contributor and with second component 1310 being quality assessment information that includes the challenge solved, the historical data used for verification and/or assessment, and the result of the assessment.

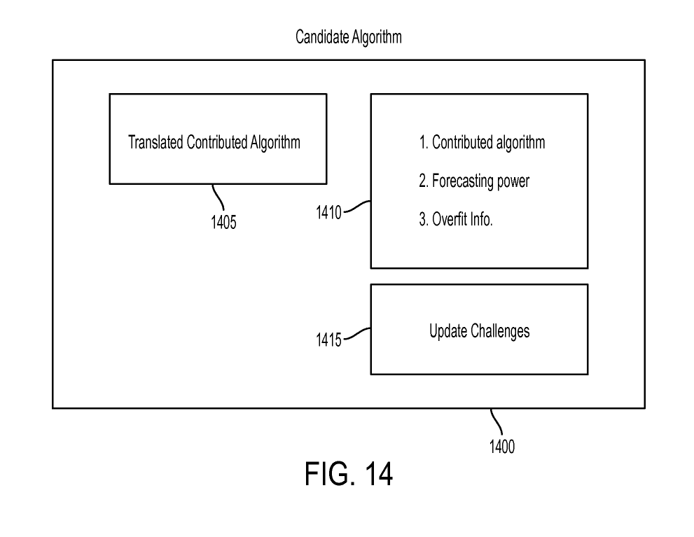

Referring to FIG. 14, this figure shows one embodiment of structure 1400 of data transmitted from the selection system to the incubation system or a data output by the incubation system. Structure 1400 may have three components, with a first component being translated contributed algorithm 1405, second component 1410 containing information regarding the contributed algorithm, forecasting power of the translated contributed algorithm, and overfitting effect of the translated contributed algorithm, and third component 1415 for updating the list of challenges.

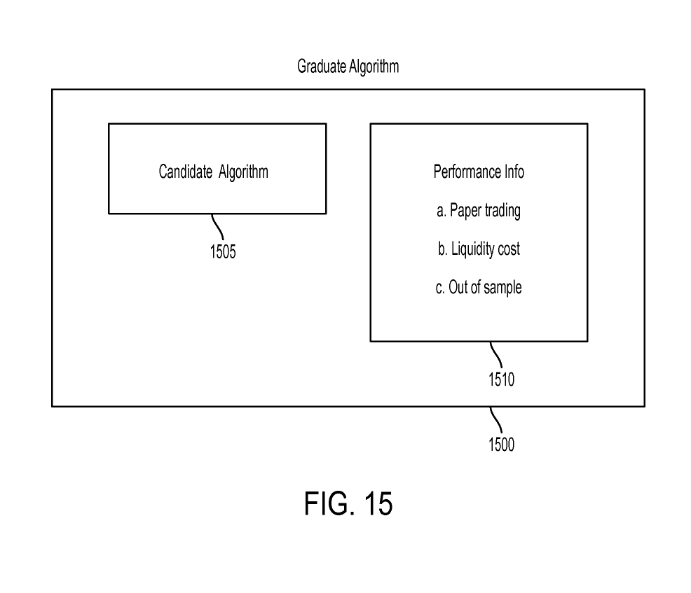

Referring to FIG. 15, this figure shows one embodiment of structure 1500 of data transmitted from the incubation system to the management system or a data output by the management system. Structure 1500 may have two components, with a first component 1505 being the candidate algorithm and a second component 1510 containing information regarding the paper trading performance, liquidity cost performance, and out-of-sample performance.

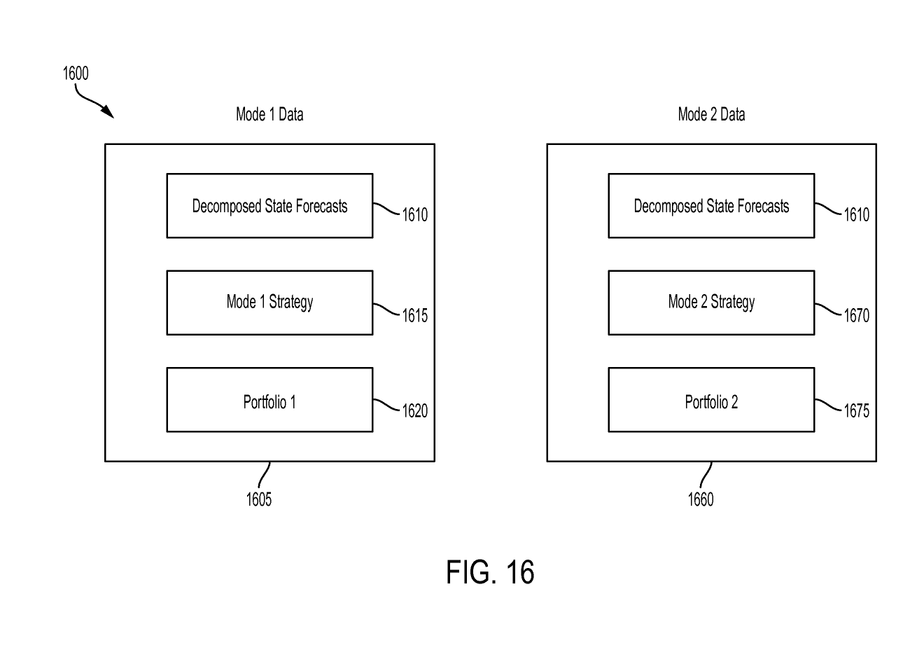

Referring to FIG. 16, this figures shows one embodiment of structure 1600 of a data output by the management system. With respect to the data being generated by the first mode, structure 1605 of that data may have three components, with first component 1610 being decomposed canonical or state forecasts, a second component containing an investment strategy, and a third component being an investment portfolio containing investments based on the investment strategy. With respect to the data being generated by the second mode, structure 1660 of that data may have three components, with first component 1665 being decomposed canonical or state forecasts, second component 1670 containing another investment strategy different from the investment strategy employed in the first mode, and third component 1675 being an investment portfolio containing investments based on the another investment strategy.

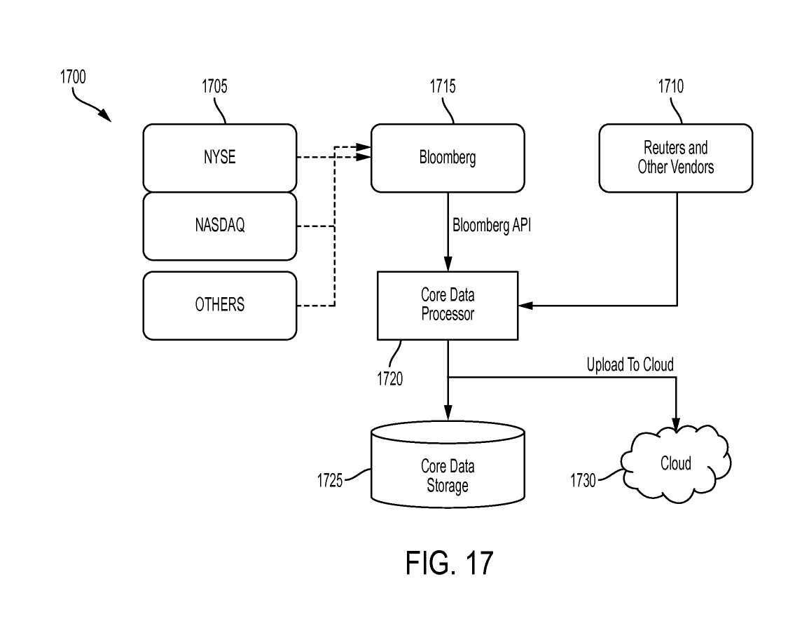

FIGS. 17-28 provide additional detailed descriptions for some embodiments of the present invention related to implementing features of the embodiments.

Referring to FIG. 17, this figure depicts one embodiment of core data management system 1700. System 1700 may comprise a plurality of vendor data sources 1705, 1710, 1715, a core data processor 1720, and core data storage 1725, and cloud-based storage 1730. The plurality of vendor sources may comprise exchanges 1705, where tradable securities, commodities, foreign exchange, futures, and options contracts are sold and bought such as NASDAQ, NYSE, BATS, Direct Edge, Euronext, ASX, and/or the like, and financial data vendors 1710, such as Reuters and other vendors. The core data may be historical or real-time data, and data may be financial or non-financial data. Historical data or historical time-series may be downloaded every day, and the system 1700 may alert any restatement to highlight potential impact on algorithms behavior. Real-time data, such as real-time trade or level-1 data, may be used for risk and paper trading. Non-financial data may include scientific data or data used and/or produced by an expert in a field other than finance or business.

Core data provided by exchanges 1705 may be supplied to and consumed by a system 1715 consuming market data. The system 1715 may be created through software development kits (such as Bloomberg API) developed Bloomberg. The data consumed by system 1715 and the data from the vendors 1710 are fed to core data processor 1720. Core data processor 1720 processes all the received data into formats usable in the development system or the system for crowdsourcing of algorithmic forecasting. The processed data is then stored in core data storage 1725 and/or uploaded to cloud 1730 for online access. Stored data or old data may be used to recreate past results, and data in storage 1725 (or local servers) and cloud 1730 (or remote servers) may be used for parallel processing (described below).

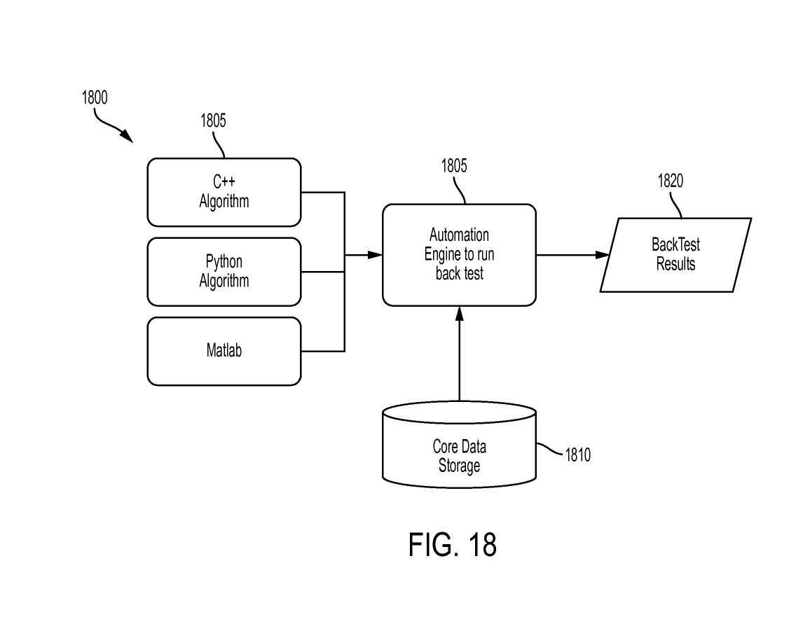

Referring to FIG. 18, this figure depicts one embodiment of a backtesting environment (e.g., for development system) 1800. The backtesting environment 1800 is an automated environment for backtesting selected algorithms from or in the development system. Algorithms may be coded in a computing environment and/or programming language 1805 such as Python, Matlab, R, Eviews, C++, or in any other environments and/or programming languages used by scientists or other experts during the ordinary course of their professional practice. The coded forecasting algorithms and the core data from core data storage 1810 are provided to automation engine 1815 to run backtest or test the coded algorithms with the core data. The automation engine 1815 then generates backtest results 1820 and the results are available in the intra web (discussed below). The backtest results may also be compared with backtest results produced previously. The system for crowdsourcing of algorithmic forecasting or the backtesting environment 1800 may keep track of backtesting results for all versions of the coded algorithms, and monitor and alert any potential issues.

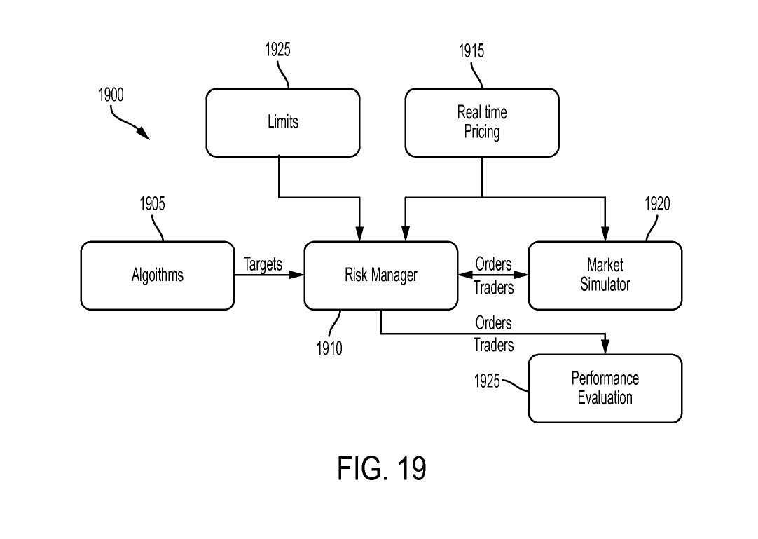

Referring to FIG. 19, this figure depicts one embodiment of paper trading or incubation system 1900. Forecasting algorithms 1905 coded in different computing environments and/or programming languages are employed to trade financial instruments, and the trades can be performed at various frequencies such as intraday, daily, etc. Coded forecasting algorithms 1905 have access to core data and core data storage such as by having access to real-time market data 1915. Targets produced by coded forecasting algorithms 1905 are processed by risk manager 1910 in real time. Targets can be individual messages or signals that are processed by risk manager 1910. Risk manager 1910 processes the targets and determines corresponding investment actions (e.g., buy, sell, quantity, type of order, duration, etc.) related to the subject of target messages (e.g., oil). The execution quality of the coded forecasting algorithms is in line with live trading. Real time market data 1915 is used for trading simulation through a market simulator 1920 and various algorithms may be used to simulate market impact. Risk manager 1910 may also perform risk checks and limits validations (or other risk or compliance evaluation) for investment activity performed by risk manager 1910. The risk manager 1910 can reject the order in case limits exceed (compared to limits 1925 previously stored or set by the user of the paper trading system 1900), be aware of corporate actions, trade based on notional targets, allow manual approval limits, and check if the order is compliance with government requirements or regulations etc. Based on the actions executed by the risk manager 1910, performance of the coded forecasting algorithms can be determined 1925. Paper trading system 1900 may further be designed with failover and DR abilities and may also monitor and alert any potential issues. The critical components of paper trading system 1900 or coded algorithms 1905 may be coded in C++.

A monitoring and alerting system may be implemented in the backtesting environment, the paper trading system, or any other system within the system for crowdsourcing of algorithmic forecasting. The monitoring and alerting system may monitor the system or environment that wants to be monitored and send various alerts or alert notifications if there are any issues. Processes and logs within each monitored system and environments are monitored for errors and warnings. Market data is also monitored keeping track of historical update frequency. Monitoring may further include expecting backtests to finish by a certain time every day and in case of issues alerts are sent.

The monitoring and alerting system may send alerts or alert notifications in various forms such as emails, text messages, and automated phone calls. The alert notifications may be sent to the contributors, the entity providing the system for crowdsourcing of algorithmic forecasting, support team, or any others to whom the alert notifications are important. In an alert notification, it may include well defined support, history of alerts raised, and available actions.

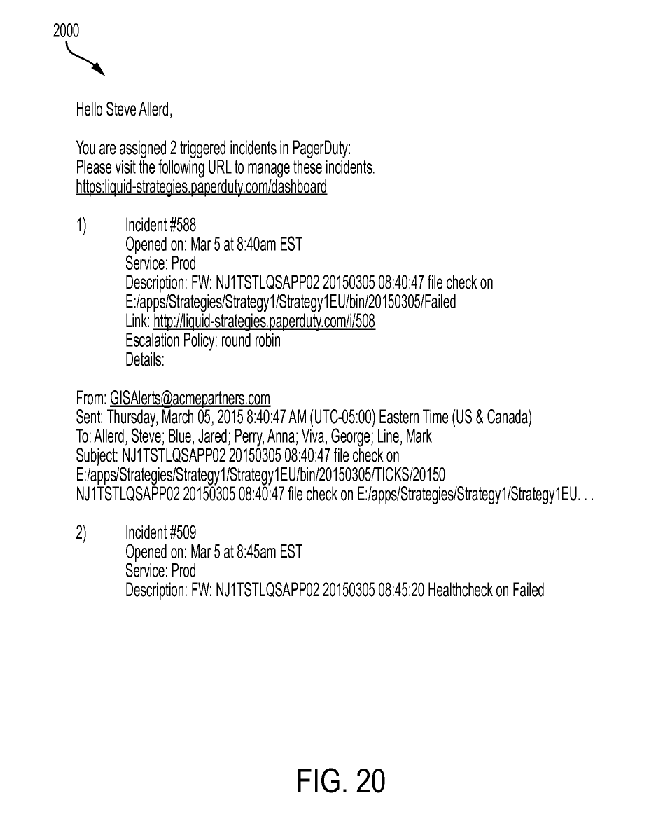

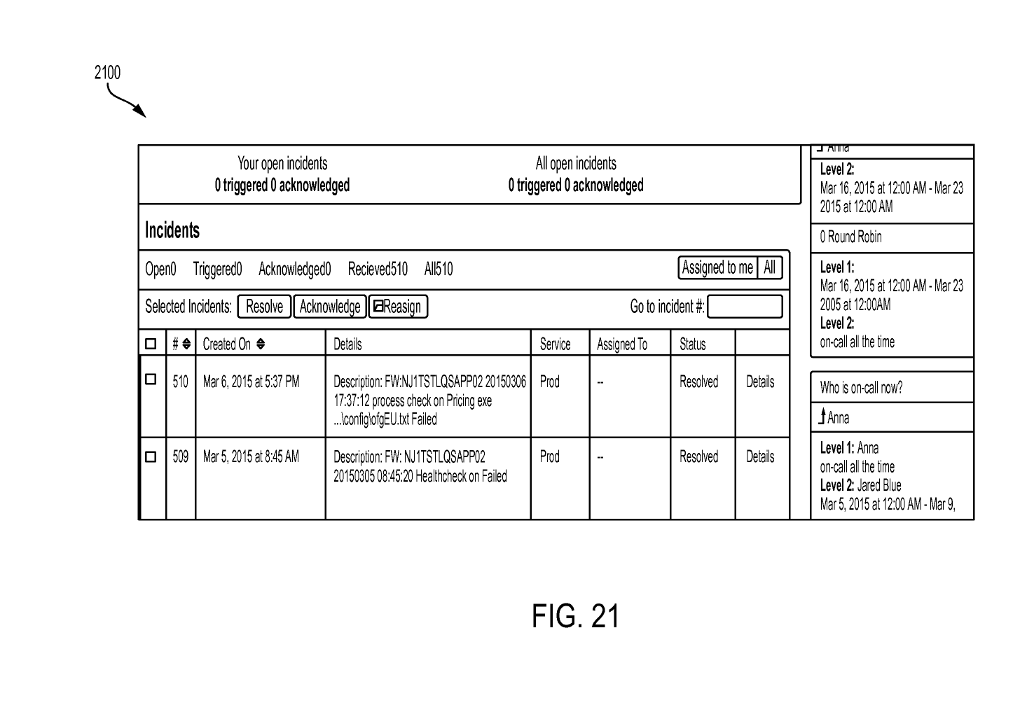

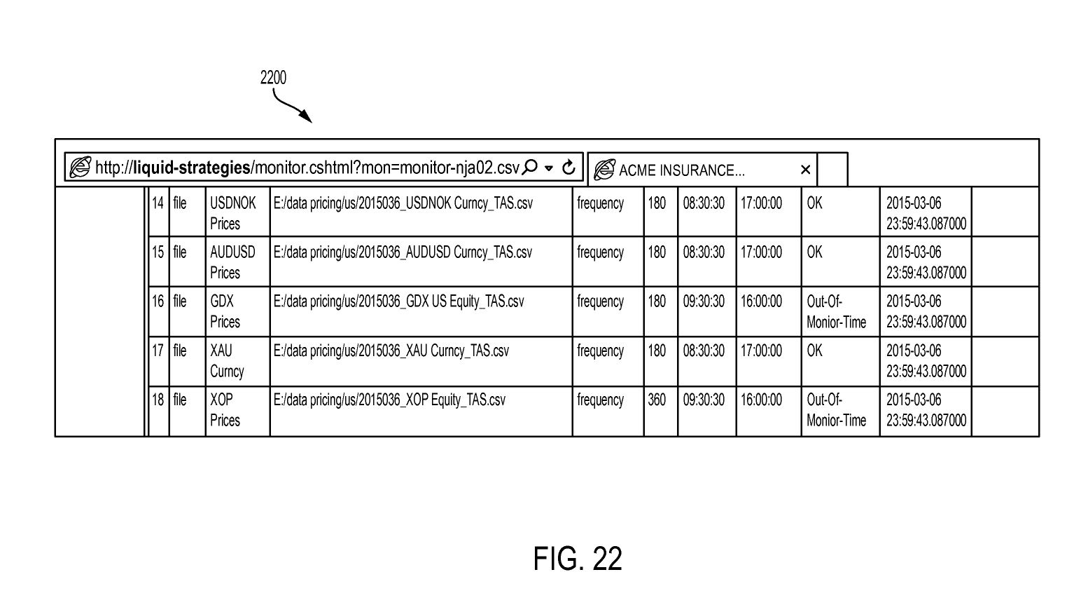

The test system may be treated as part of a production system. FIGS. 20-22 depict various embodiments of the alert notifications and alert management tools for managing the alert notifications. FIG. 20 shows an example of an email alert notification 2000, FIG. 21 shows an example of an alert management tool maintained by a third party vendor 2100, and FIG. 22 shows an example of an alert management tool on intra web 2200.

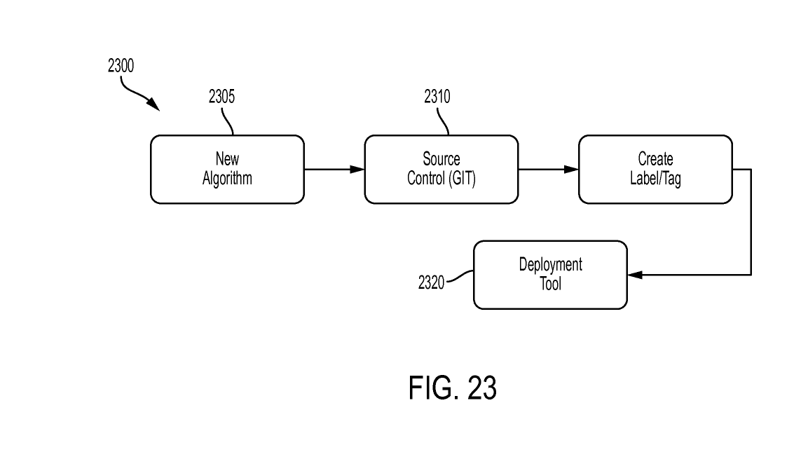

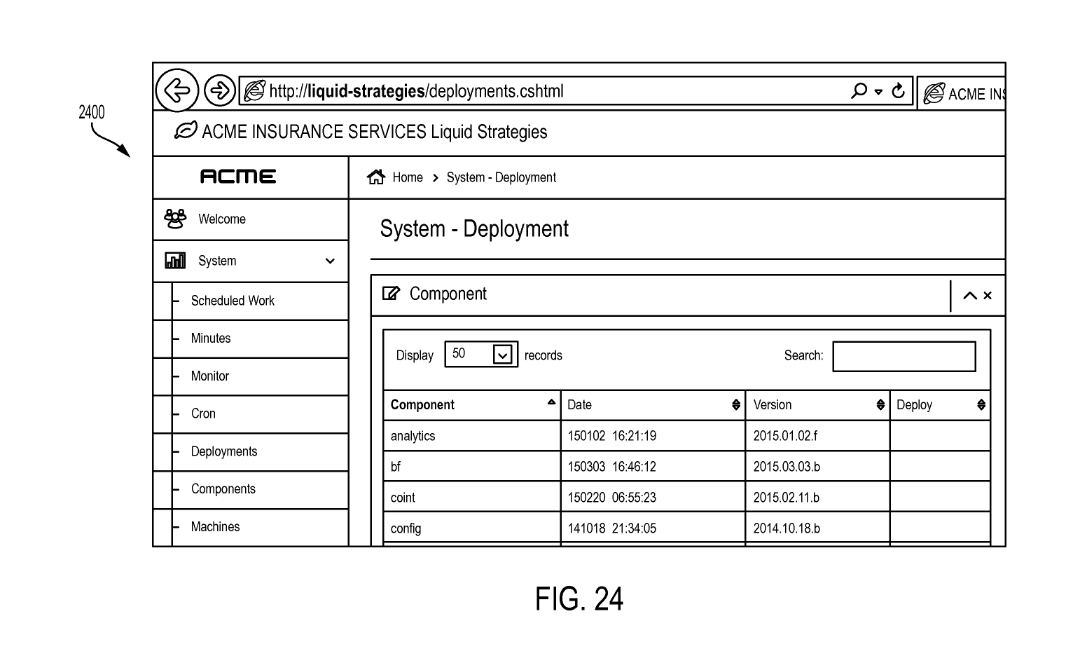

Referring to FIG. 23, this figure depicts one embodiment of deployment process system 2300. Coded algorithms or new coded algorithms 2305 may be deployed through an automated process. The deployment may be carried out through a one-click deployment using intra web. There may be controls or authentication tools in place to initiate the deployment process or to operate the deployment tool 2320 for initiating the deployment process. The deployment tool 2320 may be integrated with a source control (GIT) 2310, and it would not be possible to deploy local builds and uncommitted software. The deployment tool 2320 takes codes or algorithms from the source control (GIT) and deploys on target machine. The process is configured to create a label or tag for each algorithm that is automatically generated and assigned to individual algorithms. The process assigns a unique identifier relative to other algorithms that are on the system. The source control (GIT) 2310 implements the system source control feature that maintains source control over algorithm development without control by individual users who created them. FIG. 24 depicts a screen shot of the deployment tool screen from intra web. For example, this can be for the development system.

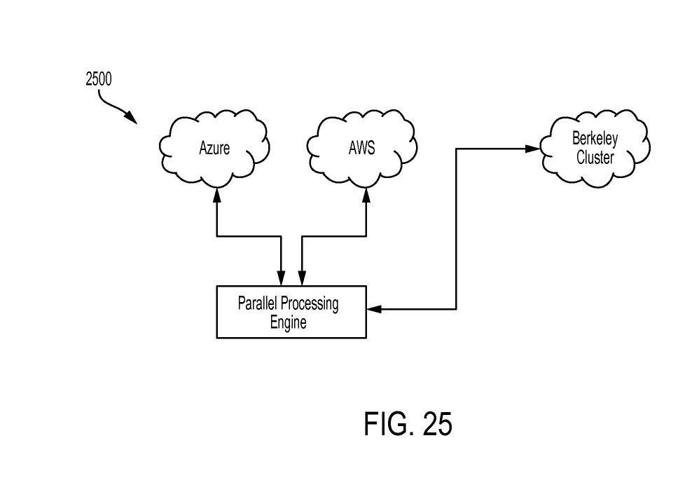

Referring to FIG. 25, this figure depicts one embodiment of a parallel processing system 2500 for implementing the various systems described herein. Algorithms are uploaded to the cloud and the parallel processing system 2500 has the ability to run on multiple cloud solutions at the same time. Both core data and market data available to the parallel processing system 2500. The parallel processing system 2500 uses proprietary framework to break jobs into smaller jobs and to manage status of each job and resubmit. The parallel processing system 2500 may have tools to monitor status and ability to resubmit individual failed jobs. The parallel processing system 2500 can access high number of cores based on need. Various algorithms may be used for parallel processing such as per symbol, per day or year based on task complexity and hardware requirements. The parallel processing system 2500 can combine results and upload back to the cloud. The results can be combined on incremental basis or full as need basis. The parallel processing system 2500 supports both Windows and Linux-based computers.

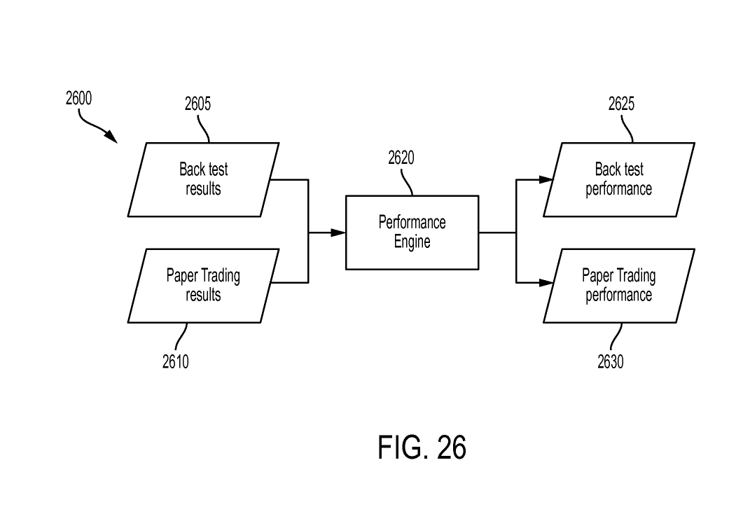

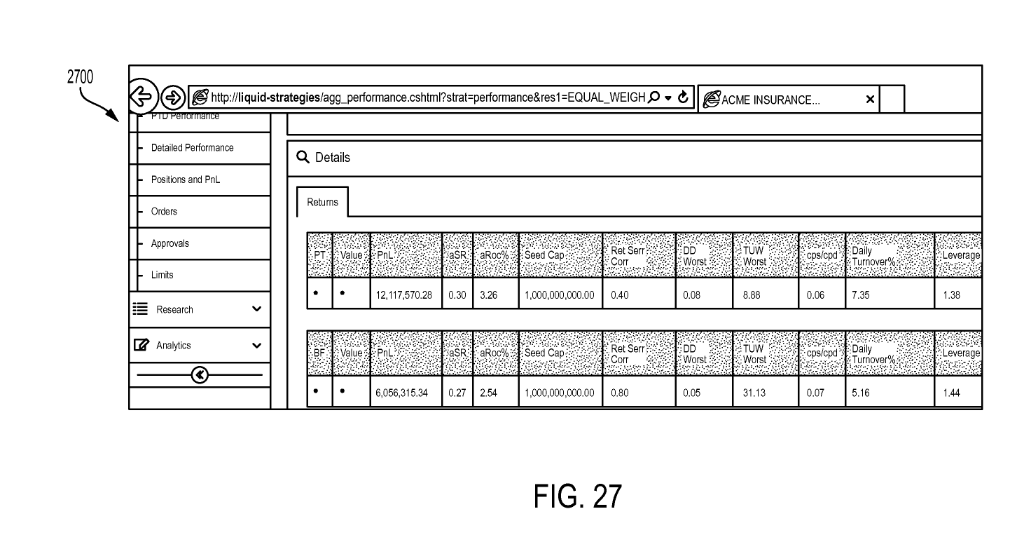

Referring to FIG. 26, this figure depicts one embodiment of a performance evaluation system 2600. The performance evaluation system 2600 comprises a performance engine 2620 that evaluates backtest results 2605 and paper trading results 2610 and that determines backtest performance 2625 and paper trading performance 2630. For backtest performance 2625, the performance may be calculated based on close price and fixed price transaction cost applied. For the paper trading performance 2630, the performance may be calculated based on trades and actual fill prices used from the risk manager. The performance evaluation system 2600 or the performance engine 2620 may compare the performances of backtest and paper trading to understand slippage. The performance evaluation system 2600 may keep track of historic performances, and versions and various other analytics. All the performance and comparison information may be made available on the intra web, and FIG. 27 is a screen shot of the performance results generated by the performance evaluation system 2600 or the performance engine 2620 on the intra web.

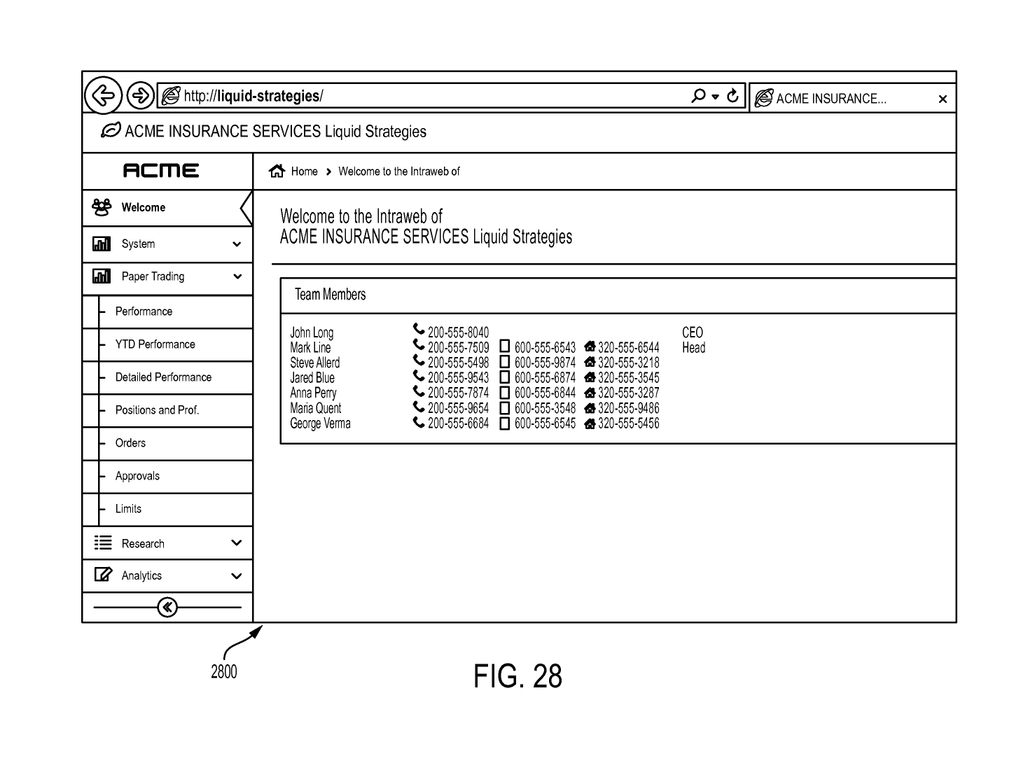

The intra web may be an internal website of the entity that provides the system for crowdsourcing of algorithmic forecasting. The intra web provides information related to algorithms and their performances, portfolio level performances, backtest and paper trading results, performances, and comparisons, real-time paper trading with live orders and trades, algorithm level limits, system monitoring and alerts, system deployment, deployment process, analytics reports for work in progress, and user level permissions and controls implements. The intra web also provides features and tools that may adjust different parameters and enable further analysis of all the above information. FIG. 28 is a screen shot of one embodiment of the intra web.

Embodiments of the present invention can take a radically different approach than known systems. Rather than selecting algorithms with a high forecasting power, a subset of algorithms that are mutually complementary among the most profitable can be selected instead. Each of the algorithms forecasts variables that can explain distinct portions of market volatility, minimizing their overlap. The outcome is a portfolio of diversified algorithms, wherein each algorithm makes a significant contribution to the overall portfolio. From the embodiments various advantages can be attained for example:
Identifying what problems are worth solving, so that researchers do not spend time working on problems that have already been cracked, or problems of little investment significance;
Allowing a large community of researchers to contribute algorithmic work without having to join a financial firm;
The forecasting algorithms do not need to be directly associated with financial variables;
Algorithmic contributions do not involve trading signals or trading rules. This means that researchers on any field can contribute to this endeavor regardless of their background or familiarity with financial concepts;
All the data, computers and specialized software needed to perform the work are provided by the system, so that the researchers can focus their efforts in solving a very specific problem: Modeling a hard-to-forecast variable from our list of outstanding problems;
The analytics engine assesses the degree of success of each algorithm. This information will guide the researcher's future efforts;
The system builds a library of contributed algorithms with links to the history of studies performed. The library of forecasting algorithms can then later be analyzed to search for profitable investment strategies. This is critical information that is needed to control for the probability of forecast overfitting (a distinctive feature of our approach). A model is considered overfit when its greater complexity generates greater forecasting power in-sample (“IS”), however this comes as a result of explaining noise rather than signal. The implication is that the forecasting power out-of-sample (“OOS”) will be much lower than what was attained IS. Thus the system can evaluate whether the performance of IS departs from the performance OOS, net of transaction costs;
Discarding unreliable candidate algorithms before they reach the production environment, thus saving capital and time;
Offering a backup analysis to the algorithm selection process by incorporating OOS evidence to the algorithm selection process;
Tracking the skills of various developers. Rankings of researchers are generated and graded certificates are issued of quantitative knowledge. Junior researchers could potentially use those certificates when applying for a job in a financial institution;
Adjusting for the performance inflation that results from running multiple trials before identifying a “candidate algorithm”. This has been identified as a critical flaw in the scientific method (refer to www.alltrials.net). But because the algorithm selection process can provide a unified research framework that logs all trials associated with a forecast, it makes it possible to assess to what extent the forecasting power is due to overfitting. As a result, a lower number of spurious algorithms will be selected, and less capital will be allocated to superfluous algorithms;
Constructing portfolios of forecasting algorithms that are resilient to changes in market regimes also known as “structural breaks” and
Identifying what challenges researchers struggle with, thus guiding the work of researchers. The more challenging a variable is to forecast, the greater the economic value. Algorithm selection process can recognize this situation thanks to its logging of all trials.

Some of the features of embodiments of the present invention that by themselves or in combination aid in achieving the aforementioned advantages include:
A system that conveys the list of open challenges, a ranking of hard-to-forecast variables, e.g. variables that are expected to generate significant profits if properly modeled, whether they are directly or indirectly related to financial instruments.
A system that collects, curates and queries Big Data sets (e.g., historical data set related to core processing).
A system that provides developers with a working environment where they can write and test their code with minimum effort.
A system that simulates the forecasts that the algorithm would have produced in history, generating proprietary analytical reports that are communicated to the researchers, so that they can improve the forecasting power of their algorithms.
A system that evaluates the probability of forecast overfitting.
A system that monitors possible fraudulent or inconsistent behavior.

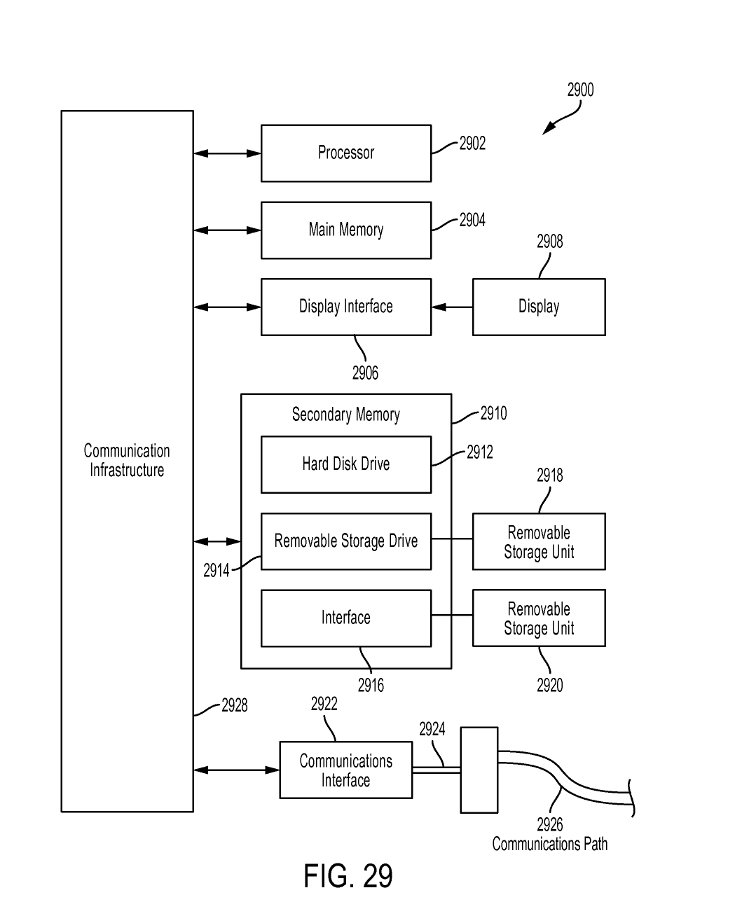

Now referring to FIG. 29, exemplary hardware and software components of computer 2900 employed in the embodiments of the present invention are shown and will be described in greater detail. Computer 2900 may be implemented by combination of hardware and software components. Although FIG. 29 illustrates only one computer, the embodiments of the present invention may employ additional computers 2900 to perform their functions if necessary. FIG. 29 depicts one embodiment of computer 2900 that comprises a processor 2902, a main memory 2904, a display interface 2906, display 2908, a second memory 2910 including a hard disk drive 2912, a removable storage drive 2914, interface 2916, and/or removable storage units 2918, 2920, a communications interface 2922 providing carrier signals 2924, a communications path 2926, and/or a communication infrastructure 2928.

In another embodiment, computer 2900, such as a server, may not include a display, at least not just for that server, and may have transient and non-transient memory such as RAM, ROM, and hard drive, but may not have removable storage. Other configuration of a server may also be contemplated.

Processor or processing circuitry 2902 is operative to control the operations and performance of computer 2900. For example, processor 2902 can be used to run operating system applications, firmware applications, or other applications used to communicate with users, online crowdsourcing site, algorithm selection system, incubation system, management system, and multiple computers. Processor 2902 is connected to communication infrastructure 2928, and via communication infrastructure 2928, processor 2902 can retrieve and store data in the main memory 2904 and/or secondary memory 2910, drive display 2908 and process inputs received from display 2908 (if it is a touch screen) via display interface 2906, and communicate with other, e.g., transmit and receive data from and to, other computers.

The display interface 2906 may be display driver circuitry, circuitry for driving display drivers, circuitry that forwards graphics, texts, and other data from communication infrastructure 2928 for display on display 2908, or any combination thereof. The circuitry can be operative to display content, e.g., application screens for applications implemented on the computer 2900, information regarding ongoing communications operations, information regarding incoming communications requests, information regarding outgoing communications requests, or device operation screens under the direction of the processor 2902. Alternatively, the circuitry can be operative to provide instructions to a remote display.

Main memory 2904 may include cache memory, semi-permanent memory such as random access memory (“RAM”), and/or one or more types of memory used for temporarily storing data. Preferably, main memory 2904 is RAM. In some embodiments, main memory 2904 can also be used to operate and store the data from the system for crowdsourcing of algorithmic forecasting, the online crowdsourcing site, the algorithm selection system, the incubation system, the management system, live environment, and/or second memory 2910.

Secondary memory 2910 may include, for example, hard disk drive 2912, removable storage drive 2914, and interface 2916. Hard disk drive 2912 and removable storage drive 2914 may include one or more tangible computer storage devices including one or more tangible computer storage devices including a hard-drive, solid state drive, flash memory, permanent memory such as ROM, magnetic, optical, semiconductor, or any other suitable type of storage component, or any combination thereof. Second memory 2910 can store, for example, data for implementing functions on the computer 2900, data and algorithms produced by the systems, authentication information such as libraries of data associated with authorized users, evaluation and test data and results, wireless connection data that can enable computer 2900 to establish a wireless connection, and any other suitable data or any combination thereof. The instructions for implementing the functions of the embodiments of the present invention may, as non-limiting examples, comprise non transient software and/or scripts stored in the computer-readable media 2910.

The removable storage drive 2914 reads from and writes to a removable storage unit 2918 in a well-known manner. Removable storage unit 2918 may be read by and written to removable storage drive 2914. As will be appreciated by the skilled artisan, the removable storage unit 2918 includes a computer usable storage medium having stored therein computer software and/or data. Removable storage is option is not typically include as part of a server.

In alternative embodiments, secondary memory 2910 may include other similar devices for allowing computer programs or other instructions to be loaded into computer 2900. Such devices may include for example a removable storage unit 2920 and interface 2916. Examples of such may include a program cartridge and cartridge interface, a removable memory chip (such as an erasable programmable read only memory (“EPROM”), or programmable read only memory (“PROM”) and associated socket, and other removable storage units 2920 and interfaces 2916, which allow software and data to be transferred from the removable storage unit 2920 to computer 2900.

The communications interface 2922 allows software and data to be transferred between computers, systems, and external devices. Examples of communications interface 2922 may include a modem, a network interface such as an Ethernet card, or a communications port, software and data transferred via communications interface 2922 are in the form of signals 2924, which may be electronic, electromagnetic, optical or other signals capable of being received by communications interface 2922. These signals 2924 are provided to communications interface 2922 via a communications path (e.g., channel) 2926. This path 2926 carries signals 2924 and may be implemented using wire or cable, fiber optics, a telephone line, a cellular link, a radio frequency (“RF”) link and/or other communications channels. As used herein, the terms “computer program medium” and “computer usable medium” generally refer to media such as transient or non-transient memory including for example removable storage drive 2914 and hard disk installed in hard disk drive 2912. These computer program products provide software to the computer 2900.

The communication infrastructure 2928 may be a communications-bus, cross-over bar, a network, or other suitable communications circuitry operative to connect to a network and to transmit communications between processor 2902, main memory 2904, display interface 2906, second memory 2910, and communications interface, and between computer 2900 or a system and other computers or systems. When the communication infrastructure 2928 is a communications circuitry operative to connect to a network, the connection may be established by a suitable communications protocol. The connection may also be established by using wires such as an optical fiber or Ethernet cable.

Computer programs also referred to as software, software application, or computer control logic are stored in main memory 2904 and/or secondary memory 2910. Computer programs may also be received via communications interface 2922. Such computer programs, when executed, enable or configure the computer 2900 to perform the features of the present invention as discussed herein. In particular, the computer programs, when executed, enable the processor 2902 to perform the features of the present invention. Accordingly, such computer programs represent controllers of the computer 2900.

In an embodiment in which the invention is implemented using software, the software may be stored in a computer program product and loaded into computer 2900 using removable storage drive 2914, hard drive 2912, or communications interface 2922. The control logic, which is the software when executed by the processor 2902 causes the processor 2902 to perform the feature of the invention as described herein.

In another embodiment, the invention is implemented primarily in hardware using for example hardware components, such as application specific integrated circuits (“ASICs”). Implementation of the hardware state machine so as to perform the functions described herein will be apparent to persons skilled in the relevant arts.

In yet another embodiment, the embodiments of the instant invention are implemented using a combination of both hardware and software.

Computer 2900 may also include input peripherals for use by users to interact with and input information into computer 2900. Users such as experts or scientists can use a computer or computer-based devices such as their PC to access and interact with the relevant systems described herein such as using a browser or other software application running on the computer or computer-based device to use the online crowdsourcing site and the development system. Computer 2900 can also be a database server for storing and maintaining a database. It is understood that it can contain a plurality of databases in the memory (in main memory 2904, in secondary memory 2910, or both). In some embodiments, a server can comprise at least one computer acting as a server as would be known in the art. The server(s) can be a plurality of the above mentioned computer or electronic components and devices operating as a virtual server, or a larger server operating as a virtual server which may be a virtual machine, as would be known to those of ordinary skill in the art. Such possible arrangements of computer(s), distributed resources, and virtual machines can be referred to as a server or server system. Cloud computing, for example, is also contemplated. As such the overall system or individual systems such as the selection system or incubation system can be implemented on a separate servers, same server, or different types of computers. Each system or combinations of systems can also be implemented on a virtual server that may be part of a server system that provides one or more virtual servers. In a preferred version, the portfolio management system is a separate system relative to the development system, selection system, and incubation system. This can maintain its security by way of features of additional security such as firewalls.

The present systems, methods, or related inventions also relate to a non-transient computer readable medium configured to carry out any one of the methods disclosed herein. The application can be a set of instructions readable by a processor and stored on the non-transient computer readable medium. Such medium may be permanent or semi-permanent memory such as hard drive, floppy drive, optical disk, flash memory, ROM, EPROM, EEPROM, etc., as would be known to those of ordinary skill in the art.

Users such as experts or scientists can use a computer or computer-based devices such as their PC to access and interact with the relevant systems described herein such as using a browser or other software application running on the computer or computer-based device to use the online crowdsourcing site and the development system.

It should be understood by those of ordinary skill in the art of computers and telecommunications that the communications illustratively described herein typically include forming messages, packets, or other electronic signals that carry data, commands, or signals, to recipients for storage, processing, and interaction. It should also be understood that such information is received and stored, such as in a database, using electronic fields and data stored in those fields.

In some embodiments, the system is implemented to monitor and record all activity within each private workspace associated with the user of that workspace in creating, modifying, and testing a particular forecast algorithm (including through each incremental version of the algorithm). The collected data is used by the system to evaluate an expert's contributed forecast algorithm that is associated with the collected data. The collected data can be data that includes the number of test trials, the type of data used for trials, diversity in the data, number of versions of the algorithm, data that characterizes the correlation of test trials, different parameters used for inputs, time periods selected for testing, and results or reports of testing performed by the expert in his or workspace (including for example the results of analytical or evaluation tools that were applied to the algorithm or the results of testing). The total number of test trials and the correlation value related to the diversity of testing can be one set of data, by itself, for example. The system can be configured to collect data that can accurately evaluate a preferred confidence level in the contributed algorithm based on information generated from the development and testing of the algorithm before the algorithm was submitted as a contributed forecasting algorithm. For example, necessary data for determining BPO can be collected and used for the evaluation. The system can perform the collection, storage, and processing (e.g., for analytics) independent of the control of the corresponding user in the workspace and as generally understood herein is performed automatically. It would be understood that preferably data (e.g., user activity in the workspace) that is unrelated to the objective such as formatting related activity or mouse locations or other trivial or unrelated data are not necessarily collected and stored. Examples of systems, formulas, or applications that support features herein are in the following articles which are incorporated herein by reference in their entirety and also included in the Appendix to this application: Bailey, David H. and Lopez de Prado, Marcos, Stop-Outs Under Serial Correlation and ‘The Triple Penance Rule’ (Oct. 1, 2014), Journal of Risk, 2014, Forthcoming, which is available at SSRN: http://ssrn.com/abstract=2201302 or http://dx.doi.org/10.21391/ssrn.2201302; Lopez de Prado, Marcos and Foreman, Matthew, A Mixture of Gaussians Approach to Mathematical Portfolio Oversight: The EF3M Algorithm (Jun. 15, 2013), Quantitative Finance, 2013, Forthcoming, which is available at SSRN: http://ssrn.com/abstract=1931734 or http://dx.doi.org/10.2139/ssrn.1931734; Bailey, David H. and Lopez de Prado, Marcos, The Sharpe Ratio Efficient Frontier (April 2012), Journal of Risk, Vol. 15, No. 2, Winter 2012/13, which is available at SSRN: http://ssrn.com/abstract=1821643 or http://dx.doi.org/10.2139/ssrn.1821643; Bailey, David H. and Lopez de Prado, Marcos, Balanced Baskets: A New Approach to Trading and Hedging Risks (May 24, 2012), Journal of Investment Strategies (Risk Journals), Vol. 1(4), Fall 2012, which is available at SSRN: http://ssrn.com/abstract=2066170 or http://dx.doi.org/10.2139/ssrn.2066170; Bailey, David H. and Lopez de Prado, Marcos and del Pozo, Eva, The Strategy Approval Decision: A Sharpe Ratio Indifference Curve Approach (Jan. 1, 2013), Algorithmic Finance, (2013) 2:1, 99-109, which is available at SSRN: http://ssrn.com/abstract=2003638 or http://dx.doi.org/10.2139/ssrn.2003638; Bailey, David H. and Lopez de Prado, Marcos, An Open-Source Implementation of the Critical-Line Algorithm for Portfolio Optimization (Feb. 1, 2013), Algorithms, 6(1), pp. 169-196, 2013, which is available at SSRN: http://sSrn.com/abstract=2197616 or http://dx.doi.org/10.2139/ssrn.21976; Easley, David and Lopez de Prado, Marcos and O'Hara, Maureen, Optimal Execution Horizon (Oct. 23, 2012), Mathematical Finance, 2013, which is available at SSRN: http://ssrn.com/abstract=2038387 or http://dx.doi.org/10.2139/ssrn.2038387; and Lopez de Prado, Marcos and Vince, Ralph and Zhu, Qiji Jim, Optimal Risk Budgeting under a Finite Investment Horizon (Dec. 24, 2013), which is available at SSRN: http://ssrn.com/abstract=2364092 or http://dx.doi.org/10.21391/ssrn.2364092.

In one respect, in some embodiments, evaluation information developed or generated in the system is progressively used in subsequent parts of the system. The application of the evaluation information, as shown, by the examples herein, provides an improved system that can generate better performance with fewer resources.

Another point of clarification relates to known existing systems in certain fields. In known financial systems, financial companies deploy portfolio management systems that automatically trade equities such as financial investments (buy/sell orders). These automated systems that detect or receive input and automatically trade are used in the financial world, but as discussed above, they have certain deficiencies and improvement of these known equipment is achieved by features of the present invention. For example, the automated trading system incorporates the improved techniques for using forecasting algorithms.

It will readily be understood by one having ordinary skill in the relevant art that the present invention has broad utility and application. Other embodiments may be discussed for additional illustrative purposes in providing a full and enabling disclosure of the present invention. Moreover many embodiments such as adaptations, variations, modifications, and equivalent arrangements will be implicitly disclosed by the embodiments described herein and fall within the scope of the present invention.

Accordingly, while the embodiments of the present invention are described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended nor is to be construed to limit the scope of patent protection afforded by the present invention, which scope is to be defined by the claims and the equivalents thereof. It is not intended that the scope of patent protection afforded the present invention be defined by reading into any claim a limitation found herein that does not explicitly appear in the claim itself.

Thus for example any sequence(s) and/or temporal order of steps of various processes or methods (or sequence of system connections or operation) that are described herein are illustrative and should not be interpreted as being restrictive. Accordingly, it should be understood that although steps of various processes or methods (or connections or sequence of operations) may be shown and described as being in a sequence or temporal order, but they are not necessary limited to being carried out in any particular sequence or order. For example, the steps in such processes or methods generally may be carried out in various different sequences and orders, while still falling within the scope of the present invention. In addition systems or features described herein are understood to include variations in which features are removed, reordered, or combined in a different way.

Additionally it is important to note that each term used herein refers to that which the ordinary artisan would understand such term to mean based on the contextual use of such term herein. It would be understood that terms that have component modifiers are intended to communicate the modifier as a qualifier characterizing the element, step, system, or component under discussion.

Although the present invention has been described and illustrated herein with referred to preferred embodiments, it will be apparent to those of ordinary skill in the art that other embodiments may perform similar functions and/or achieve like results. Thus it should be understood that various features and aspects of the disclosed embodiments can be combined with or substituted for one another in order to form varying modes of the disclosed invention.

What is claimed is:

1. A computer-implemented system for automatically generating financial investment portfolios, comprising:
an online crowdsourcing site comprising one or more servers and associated software that configures the servers to provide the crowdsourcing site and further comprising a database of open challenges and historic data, wherein on the severs, the site:
registers experts, accessing the site from their computers, to use the site over a public computer network,
publishes challenges on the public computer network wherein the challenges include challenges that define needed individual scientific forecasts for which forecasting algorithms are sought,
implements an algorithmic developer's sandbox that comprises:
individual private online workspaces that are available remotely accessible for use to each registered expert and which include a partitioned integrated development environment comprising online access to:
algorithm development software,
historic data,
forecasting algorithm evaluation tools including one or more tools for performing test trials using the historic data, and
a process for submitting one of the expert's forecasting algorithms authored in their private online workspace to the system as a contributed forecasting algorithm for inclusion in a forecasting algorithm portfolio;
an algorithm selection system comprising one or more servers and associated software that configures the servers to provide the algorithm selection system, wherein on the servers, the algorithm selection system:
receives the contributed forecast algorithms from the algorithmic developer's sandbox,
monitors user activity inside the private online workspaces including user activity related to the test trials performed within the private online workspaces on the contributed forecasting algorithms before the contributed forecasting algorithms were submitted to the system,
determines, from the monitored activity, test related data about the test trials performed in the private online workspaces on the contributed forecasting algorithms including identifying a specific total number of times a trial was actually performed in the private online workspace on the contributed forecasting algorithm by the registered user,
determines accuracy and performance of the contributed forecasting algorithms using historical data and analytics software tools including determining, from the test related data, a corresponding probability of backtest overfitting associated with individual ones of the contributed forecasting algorithms, and
based on determining accuracy and performance, identifying a subset of the contributed forecasting algorithms to be candidate forecasting algorithms;
an incubation system comprising one or more servers and associated software that configures the servers to provide the incubation system, wherein on the servers, the incubation system:
receives the candidate forecasting algorithms from the algorithm selection system,
determines an incubation time period for each of the candidate forecasting algorithms by receiving the particular probability of backtest overfitting for the candidate forecasting algorithms and receiving minimum and maximum ranges for the incubation time period,
in response, determining a particular incubation period that varies between the maximum and minimum period based primarily on the probability of backtest overfitting associated with that candidate forecasting algorithm, whereby certain candidate forecasting algorithms will have a much shorter incubation period than others;
includes one or more sources of live data that are received into the incubation system,
applies the live data to the candidate forecasting algorithms for a period of time specified by corresponding incubation time periods,
determines accuracy and performance of the candidate forecasting algorithms in response to the application of the live data including by determining accuracy of output values of the candidate forecast algorithms when compared to actual values that were sought to be forecasted by the candidate forecasting algorithms, and
in response to determining accuracy and performance of the candidate forecasting algorithms, identifies and stores a subset of the candidate forecasting algorithms as graduate forecasting algorithms as a part of a portfolio of operational forecasting algorithms that are used to forecast values in operational systems.

2. The system of claim 1, wherein the system implements a source control system that tracks iterative versions of individual forecast algorithms while the forecast algorithms are authored and modified by users in their private workspace.

3. The system of claim 2, wherein the system determines test related data about test trials performed in the private workspace in specific association with corresponding versions of an individual forecasting algorithm, whereby the algorithm selection system determines the specific total number of times each version of the forecasting algorithm was tested by the user who authored the forecasting algorithm.

4. The system of claim 2, wherein the system determines the probability of backtest overfitting using information about version history of an individual forecast algorithm as determined from the source control system.

5. The system of claim 2, wherein the system associates a total number of test trials performed by users in their private workspace in association with a corresponding version of the authored forecasting algorithm by that user.

6. The system of claim 5, wherein the system determines, from the test data about test trials including a number of test trials and the association of some of the test trials with different versions of forecast algorithms, the corresponding probability of backtest overfitting.

7. The system of claim 1, wherein the system includes a fraud detection system that receives and analyzes contributed forecasting algorithms and determines whether some of the contributed forecasting algorithms demonstrate fraudulent behavior.

8. The system of claim 1, wherein the online crowdsourcing site applies an authorship tag to contributed forecasting algorithm and the system maintains the authorship tag in connection with the contributed forecasting algorithm including as part of a use of the contributed forecasting algorithm as a graduate forecasting algorithm in operation use.

9. The system of claim 8, wherein the system determines corresponding performance of graduate algorithms and generates an output in response to the corresponding performance that is communicated to the author identified by the authorship tag.

10. The system of claim 9, wherein the output communicates a reward.

11. The system of claim 1, wherein the system further comprises a ranking system that ranks challenges based on corresponding difficulty.

12. The system of claim 1, wherein the algorithm selection system includes a financial translator that comprises different sets of financial characteristics that are associated with specific open challenges, wherein the algorithm selection system determines a financial outcome from at least one of the contributed forecasting algorithms by applying the set of financial characteristics to the at least one of the contributed forecast algorithms.

13. The system of claim 1 further comprising a portfolio management system comprising one or more servers, associated software, and data that configure the servers to implement the portfolio management system, wherein on the servers, the portfolio management system:
receives graduate forecasting algorithms from the incubation system,
stores graduate forecasting algorithms in a portfolio of graduate forecasting algorithms,
applies live data to the graduate forecasting algorithms and in response receives output values from the graduate forecasting algorithms,
determines directly or indirectly, from individual forecasting algorithms and their corresponding output values, specific financial transaction orders, and
transmits the specific financial transaction orders over a network to execute the order.

14. The system of claim 13 wherein the portfolio management system comprises at least two operational modes, wherein in a first mode, the portfolio management system processes and applies graduate forecasting algorithms that are defined to have an output that is a financial output and the portfolio management system determines from the financial output the specific financial order.

15. The system of claim 14 wherein the portfolio management system comprises a second mode, and in the second mode, the portfolio management system processes and applies graduate forecasting algorithm that are defined to have an output that is a scientific output, applies a financial translator to the scientific output, and the portfolio management system determines from the output of the financial translator a plurality of specific financial orders that when executed generate or modify a portfolio of investments that are based on the scientific output.

16. The system of claim 13 wherein the portfolio management system is further configured to:
evaluate actual performance outcomes for graduate forecasting algorithms against expected or predetermined threshold performance outcomes for corresponding graduate forecast algorithm,
based on the evaluation, determine underperforming graduate forecasting algorithms,
remove underperforming graduate forecasting algorithms from the portfolio, and
communicate actual performance outcomes, the removal of graduate algorithms, or a status of graduate forecasting algorithms to other components in the computer-implemented system.

17. The system of claim 13 wherein the portfolio management system:
evaluates performance of graduate forecasting algorithms by performing a simulation after live trading is performed that varies input values and determines variation in performance of the graduate forecasting algorithm portfolio in response to the varied input values, and
determines from the variations in performance to which ones of the graduate forecasting algorithms in the portfolio the variations should be attributed.

18. The system of claim 1 wherein the algorithm selection system is further configured to include a marginal contribution component that:
determines a marginal forecasting power of a contributed forecasting algorithm, by comparing the contributed forecasting algorithm to a portfolio of graduate forecasting algorithm operating in production in live trading,
determines based on the comparison a marginal value of the contributed forecasting algorithm with respect to accuracy, performance, or output diversity when compared to the graduate forecasting algorithms, and
in response the algorithm selection system (in response to itself?) determines which contributed forecasting algorithm should be candidate forecasting algorithm based at least partly on the marginal value.

19. The system of claim 1 wherein the algorithm selection system is further configured to include a scanning component that scans contributed forecasting algorithms and in scanning searches for different contributed forecasting algorithms that are mutually complementary.

20. The system of claim 19 wherein the scanning component determines a subset of the contributed forecasting algorithms that have defined forecast outputs that do not overlap.

21. The system of claim 1 wherein the incubation system further comprises a divergence component that:
receives and evaluates performance information related to candidate forecasting algorithm,
over time, determines whether the performance information indicates that individual candidate forecasting algorithm systems have diverged from in sample performance values determined prior to the incubation system, and
terminates the incubation period for candidate forecasting algorithm that have diverged from their in-sample performance value by a certain threshold.

22. A computer-implemented system for automatically generating financial investment portfolios, comprising:
an online crowdsourcing site comprising one or more servers and associated software that configures the servers to provide the crowdsourcing site and further comprising a database of challenges and historic data, wherein on the severs, the site:
publishes challenges to be solved by users,
implements a development system that comprises:
individual private online workspaces to be used by the users comprising online access to:
algorithm development software for solving the published challenges to create forecasting algorithms,
historic data,
forecasting algorithm evaluation tools for performing test trials using the historic data, and
a process for submitting the forecasting algorithms to the computer-implemented system as contributed forecasting algorithms;
an algorithm selection system comprising one or more servers and associated software that configures the servers to provide the algorithm selection system, wherein on the servers, the algorithm selection system:
receives the contributed forecast algorithms from the development system,
determines a corresponding probability of backtest overfitting associated with individual ones of the received contributed forecasting algorithms, and
based on the determined corresponding probability of backtest overfitting, identifies a subset of the contributed forecasting algorithms to be candidate forecasting algorithms;
an incubation system comprising one or more servers and associated software that configures the servers to provide the incubation system, wherein on the servers, the incubation system:
receives the candidate forecasting algorithms from the algorithm selection system,
determines an incubation time period for each of the candidate forecasting algorithms,
applies live data to the candidate forecasting algorithms for a period of time specified by corresponding incubation time periods,
determines accuracy and performance of the candidate forecasting algorithms in response to the application of the live data, and
in response to determining accuracy and performance of the candidate forecasting algorithms, identifies and stores a subset of the candidate forecasting algorithms as graduate forecasting algorithms as a part of a portfolio of operational forecasting algorithms that are used to forecast values in operational systems.

23. A computer-implemented system for automatically generating financial investment portfolios, comprising:
a site comprising one or more servers and associated software that configures the servers to provide the site and further comprising a database of challenges, wherein on the severs, the site:
publishes challenges to be solved by users,
implements a first system that comprises:
individual workspaces to be used by the users comprising access to:
algorithm development software for solving the published challenges to create forecasting algorithms, and
a process for submitting the forecasting algorithms to the computer-implemented system as contributed forecasting algorithms;
a second system comprising one or more servers and associated software that configures the servers to provide the second system, wherein on the servers, the second system:
evaluates the contributed forecast algorithms, and
based on the evaluation, identifies a subset of the contributed forecasting algorithms to be candidate forecasting algorithms;
a third system comprising one or more servers and associated software that configures the servers to provide the third system, wherein on the servers, the third system:
determines a time period for each of the candidate forecasting algorithms,
applies live data to the candidate forecasting algorithms for corresponding time periods determined,
determines accuracy and performance of the candidate forecasting algorithms in response to the application of the live data, and
based on the determination of accuracy and performance, identifies a subset of the candidate forecasting algorithms as graduate forecasting algorithms, the graduate forecasting algorithms are a part of a portfolio of operational forecasting algorithms that are used to forecast values in operational systems.

24. A computer implemented system for developing forecasting algorithms, comprising:
a crowdsourcing site which is open to the public and publishes open challenges for solving forecasting problems; wherein the site includes individual private online workspace including development and testing tools used to develop and test algorithms in the individual workspace and for users to submit their chosen forecasting algorithm to the system for evaluation;
a monitoring system that monitors and records information from each private workspace that encompasses how many times a particular algorithm or its different versions were tested by the expert and maintains a record of algorithm development, wherein the monitoring and recording is configured to operate independent of control or modification by the experts;
a selection system that evaluates the performance of submitted forecasting algorithms by performing backtesting using historic data that is not available to the private workspaces, wherein the selection system selects certain algorithms that meet required performance levels and for those algorithms, determines a probability of backtest overfitting and determines from the probability, a corresponding incubation period for those algorithm that varies based on the probability of backtest overfitting.

25. The system of claim 1 further comprising a portfolio management system that comprises a quantum computer configured with software that together processes graduate forecasting algorithms and indirect cost of associated financial activity and in response determines modifications to financial transaction orders before being transmitted, wherein the portfolio management system modifies financial transaction orders to account for overall profit and loss evaluations over a period of time.

26. The system of claim 13 wherein the portfolio management system comprises a quantum computer that is configured with software that together processes graduate forecasting algorithms by generating a range of parameter values for corresponding financial transaction orders, partitioning the range, associating each partition with a corresponding state of a qubit, evaluating expected combinatorial performance of multiple algorithms overtime using the states of associated qubits, and determining as a result of the evaluating, the parameter value in the partitioned range to be used in the corresponding financial transaction order before the corresponding financial transaction order is transmitted for execution.
